(19) United States
(12) Patent Application Publication
(10) Pub. No.: US 2025/0334810 A1
(43) Pub. Date: Oct. 30, 2025

(54) DISPLAY DEVICE

(71) Applicant: SONY GROUP CORPORATION, TOKYO (JP)

(72) Inventor: AKIRA YOSHIKAIE, TOKYO (JP)

(21) Appl. No.: 18/868,512

(22) PCT Filed: Apr. 17, 2023
(86) PCT No.: PCT/JP2023/015352

§ 371 Date: Nov. 22, 2024

(30) Foreign Application Priority Data
Jun. 1, 2022 (JP) 2022-089550

(51) Int. Cl. G02B 27/01; G02B 27/09; G02B 27/28; G02B 27/42

(52) U.S. Cl. CPC G02B 27/0172; G02B 27/0944; G02B 27/286; G02B 27/4211; G02B 2027/0123

(57) ABSTRACT

There is provided a display device capable of stably displaying a wide angle-of-view image with high image quality while suppressing an increase in size and crosstalk.

The display device according to the present technology includes: an image light generation system that generates image light; and a light guide system that guides the image light generated by the image light generation system to an eyeball of a user, in which the light guide system includes a diffraction unit having polarization selectivity, at least light in a corresponding polarization state, the at least light being included in the image light is incident on the diffraction unit, and the diffraction unit diffracts the light in the corresponding polarization state, the at least light being incident, toward the eyeball. According to the display device according to the present technology, the display device capable of stably displaying a wide angle-of-view image with high image quality while suppressing an increase in size and crosstalk can be provided.

### TECHNICAL FIELD

The technology according to the present disclosure (hereinafter also referred to as the “present technology”) relates to a display device.

### BACKGROUND ART

Conventionally, a display device that displays a wide angle-of-view image by irradiating an eyeball of a user with image light including a plurality of lights via a diffraction unit is known (for example, see Patent Document 1). However, in this display device, there is room for improvement in displaying a wide angle-of-view image while suppressing an increase in size and crosstalk.

Therefore, there has been proposed a display device that displays an image by irradiating an eyeball of a user with image light including a plurality of lights having different wavelengths via a diffraction unit having wavelength selectivity (for example, see Patent Document 2). According to this display device, it is possible to display a wide angle-of-view image while suppressing an increase in size and crosstalk.

### CITATION LIST

### Patent Document

Patent document 1: Japanese Patent Application Laid-Open No. 2018-54978

Patent document 2: WO 2021/220638 A

### SUMMARY OF THE INVENTION

### Problems to be Solved by the Invention

In this display device (for example, see Patent Document 2), the wavelength band in which the diffraction unit has desired diffraction efficiency is narrow, and there is a possibility that the wavelength of light incident on the diffraction unit deviates from the wavelength band due to, for example, a change in the emission wavelength of the light source due to a temperature change or the like, and desired diffraction efficiency cannot be obtained. However, in this display device, there is room for improvement in stably displaying a wide angle-of-view image with high image quality.

Therefore, a main object of the present technology is to provide a display device capable of stably displaying a wide angle-of-view image with high image quality while suppressing an increase in size and crosstalk.

### Solutions to Problems

The present technology provides a display device including:
an image light generation system that generates image light; and
a light guide system that guides the image light generated by the image light generation system to an eyeball of a user;
in which the light guide system includes a diffraction unit having polarization selectivity,
at least light in a corresponding polarization state, the at least light being included in the image light, is incident on the diffraction unit, and
the diffraction unit diffracts the light in the corresponding polarization state, the at least light being incident, toward the eyeball.

The light guide system may include a plurality of the diffraction units.

At least two diffraction units of the plurality of diffraction units may correspond to different polarization states.

At least two diffraction units of the plurality of diffraction units may correspond to a same polarization state.

The plurality of diffraction units may include at least two diffraction units corresponding to different polarization states and at least two diffraction units corresponding to a same polarization state.

The plurality of diffraction units may each cause light in a corresponding polarization state to be incident on the eyeball from directions different from each other.

The light guide system may include a light guide plate that faces the eyeball and totally reflects and guides the image light which is generated by the image light generation system and is incident, and the plurality of diffraction units may be provided on the light guide plate.

The plurality of diffraction units may include at least one diffraction unit provided on a surface of the light guide plate on a side of the eyeball and/or at least one diffraction unit provided on a surface of the light guide plate on a side opposite to the side of the eyeball.

The light guide system may include a relay optical system that causes the image light generated by the image light generation system to be incident on the light guide plate at an incident angle at which the image light is totally reflected in the light guide plate.

The light in the corresponding polarization state may be circularly polarized light, and the diffraction unit may have circular polarization selectivity.

The light in the corresponding polarization state may be circularly polarized light, the plurality of diffraction units may include a first diffraction unit on which at least first circularly polarized light of the image light is incident and a second diffraction unit on which at least second circularly polarized light having a polarization direction different from a polarization direction of the first circularly polarized light, the second circularly polarized light being included in the image light, is incident, the first diffraction unit may have polarization selectivity for the first circularly polarized light, and the second diffraction unit may have polarization selectivity for the second circularly polarized light.

Each of the first diffraction unit and the second diffraction unit may have a cholesteric liquid crystal element.

A rotation direction of a liquid crystal molecule in the cholesteric liquid crystal element of the first diffraction unit may be opposite to a rotation direction of a liquid crystal molecule in the cholesteric liquid crystal element of the second diffraction unit.

In the cholesteric liquid crystal element of each of the first diffraction unit and the second diffraction unit, an alignment direction of a liquid crystal molecule may be inclined with respect to a thickness direction of the cholesteric liquid crystal element.

The light guide system may include at least one retardation film arranged on an optical path of the image light.

The diffraction unit may include a diffraction unit in which a plurality of diffraction patterns corresponding to different polarization states is formed in a multiple manner or a diffraction unit in which a plurality of layers in which diffraction patterns corresponding to different polarization states are formed is stacked.

The image light generation system may include a light source unit including a light source, and an optical deflector that deflects light from the light source unit.

The image light generation system may include another diffraction unit that is arranged on an optical path of the image light between the light source unit and the optical deflector and corrects chromatic aberration of the diffraction unit.

The image light generation system may include an optical element that is arranged on an optical path of the image light between the light source unit and the optical deflector, and an optical element control unit that controls the optical element.

A plurality of lights having different polarization states, the plurality of lights being included in the image light, may be incident on the plurality of corresponding diffraction units in different time zones.

### BRIEF DESCRIPTION OF DRAWINGS

FIGS. 1A and 1B are diagrams for explaining problems of display devices of Comparative Examples 1 and 2, respectively.

FIGS. 2A and 2B are diagrams for explaining problems of a display device of Comparative Example 3.

FIG. 3 is a graph illustrating a relationship between an angle of view of a display image and a thickness of a light guide plate, regarding a light guide plate using a normal diffraction unit and a light guide plate using diffraction units having selectivity.

FIG. 4A is a schematic configuration diagram for explaining a concept of a display device according to the present technology. FIG. 4B illustrates graphs each illustrating a relationship between the wavelength of a polarized light and the diffraction efficiency of the corresponding diffraction unit in the display device according to the present technology.

FIG. 5A is a schematic configuration diagram illustrating an—eye relief of the display device according to the present technology. FIG. 5B is a graph illustrating the relationship between the eye relief and the angle of view of a display image, regarding the display device according to the present technology and a display device using a normal light guide plate.

FIG. 6 is a diagram illustrating a configuration of a display device according to a first embodiment of the present technology.

FIG. 7 is a diagram illustrating a configuration example of a light source unit of the display device in FIG. 6.

FIG. 8 is a diagram illustrating a configuration of a display device according to Example 1 of a second embodiment of the present technology.

FIGS. 9A and 9B are a side view and a plan view, respectively, of Configuration Example 1 of a diffraction unit.

FIGS. 10A and 10B are diagrams illustrating circular polarization selectivity of Configuration Example 1 of the diffraction unit.

FIGS. 11A and 11B are views illustrating arrays of liquid crystal molecules in a first diffraction unit and a second diffraction unit, respectively.

FIGS. 12A and 12B are a side view and a plan view, respectively, of Configuration Example 2 of the diffraction unit.

FIGS. 13A and 13B are diagrams illustrating polarization selectivity of Configuration Example 2 of the diffraction unit.

FIGS. 14A to 14C are views illustrating Configuration Examples 1 to 3 of the diffraction unit, respectively.

FIG. 15 is a diagram illustrating a configuration of a display device according to Example 2 of the second embodiment of the present technology.

FIG. 16 is a diagram illustrating a configuration of a display device according to Example 3 of the second embodiment of the present technology.

FIG. 17 is a diagram illustrating a configuration of a display device according to Example 4 of the second embodiment of the present technology.

FIG. 18 is a diagram illustrating a configuration of a display device according to Example 5 of the second embodiment of the present technology.

FIG. 19 is a diagram illustrating a configuration of a display device according to Example 6 of the second embodiment of the present technology.

FIG. 20 is a diagram illustrating a configuration of a display device according to a third embodiment of the present technology.

FIG. 21 is a diagram illustrating a configuration of a display device according to a fourth embodiment of the present technology.

FIG. 22 is a block diagram illustrating functions of the display device according to the fourth embodiment of the present technology.

FIG. 23 is a diagram illustrating operation (part 1) of the display device according to the fourth embodiment of the present technology.

FIG. 24 is a diagram illustrating operation (part 2) of the display device according to the fourth embodiment of the present technology.

FIG. 25 is a diagram illustrating a configuration of a display device according to a fifth embodiment of the present technology.

FIG. 26 is a diagram illustrating a configuration example of a light source unit of the display device in FIG. 25.

FIG. 27A is a diagram illustrating an example in which the diffraction units are densely provided on both surfaces of a light guide plate. FIG. 27B is a diagram illustrating an example in which diffraction units are provided on one surface of the light guide plate.

FIG. 28 is a diagram illustrating a configuration of a display device according to a sixth embodiment of the present technology.

FIG. 29A is a diagram illustrating a configuration of a display device according to Example 1 of a seventh embodiment of the present technology. FIG. 29B is a diagram for explaining a display method of the display device in FIG. 29A.

FIG. 30 is a diagram illustrating a configuration example of a light source unit of the display device in FIG. 29A.

FIG. 31A is a diagram illustrating a configuration of a display device according to Example 2 of the seventh embodiment of the present technology. FIG. 31B is a diagram for explaining a display method of the display device in FIG. 31A.

FIG. 32 is a diagram illustrating a configuration example of a light source unit of the display device in FIG. 31A.

FIG. 33A is a diagram illustrating a configuration of a display device according to Example 3 of the seventh embodiment of the present technology. FIG. 33B is a diagram for explaining a display method of the display device in FIG. 33A.

FIG. 34 is a diagram illustrating a configuration of Modification 1 of a relay optical system.

FIG. 35 is a diagram illustrating a configuration of Modification 2 of the relay optical system.

### MODE FOR CARRYING OUT THE INVENTION

Hereinafter, preferred embodiments of the present technology will be described in detail with reference to the accompanying drawings. Note that, in the present specification and the drawings, components having substantially the same functional configurations are denoted by the same reference signs, and redundant descriptions are omitted. The embodiments to be described below provide representative embodiments of the present technology, and the scope of the present technology is not to be narrowly interpreted according to those embodiments. In the present specification, even in a case where it is described that a display device according to the present technology exhibits a plurality of effects, a display device according to the present technology is only required to exhibit at least one effect. The effects described in the present specification are merely examples and are not limited, and other effects may be exerted.

Furthermore, the description will be given in the following order.
0. Introduction
1. Display Device According to First Embodiment of Present Technology
2. Display Device According to Second Embodiment of Present Technology
3. Display Device According to Third Embodiment of Present Technology
4. Display Device According to Fourth Embodiment of Present Technology
5. Display Device According to Fifth Embodiment of Present Technology
6. Display Device According to Sixth Embodiment of Present Technology
7. Display Device According to Seventh Embodiment of Present Technology
8. Modification of Present Technology

### 0. Introduction

### (Problems of Comparative Examples)

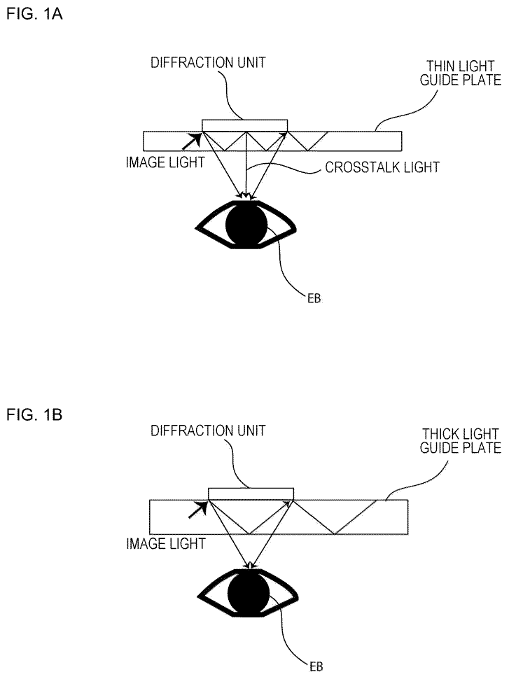

FIGS. 1A and 1B are diagrams for explaining problems of display devices of Comparative Examples 1 and 2, respectively. In the display device of Comparative Example 1 illustrated in FIG. 1A, image light is totally reflected and propagated in a light guide plate, and diffracted toward an eyeball EB by a diffraction unit to form a wide angle-of-view image. However, in this display device, if the light deflection width in the light guide plate is small (for example, if the light guide plate is thin), light having the same information is incident on a plurality of different locations on the diffraction unit (incident on the diffraction unit a plurality of times), and the eyeball is irradiated with the light at different angles of view, which causes crosstalk. Therefore, by increasing the light deflection width (for example, thickening the light guide plate) as in the display device of Comparative Example 2 illustrated in FIG. 1B, the crosstalk can be suppressed, but in this case, an increase in size is caused.

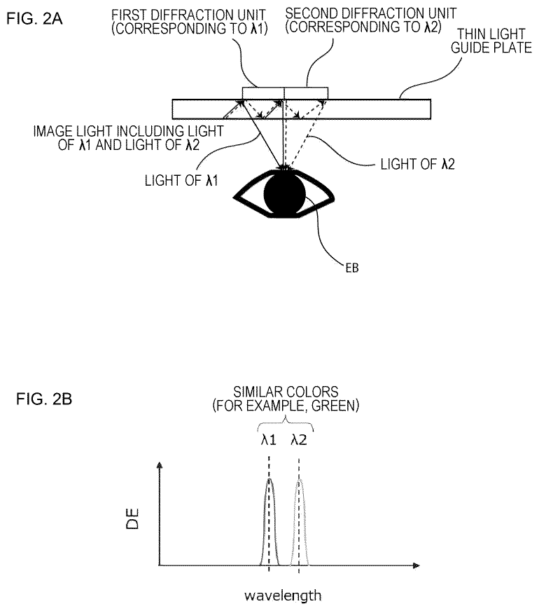

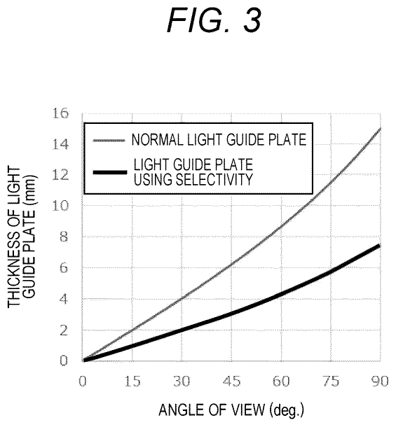

FIGS. 2A and 2B are diagrams for explaining problems of a display device of Comparative Example 3. Notation DE on the vertical axis in FIG. 2B represents diffraction efficiency. The display device of Comparative Example 3 illustrated in FIG. 2A totally reflects and propagates image light including a plurality of lights having different wavelengths (for example, wavelengths λ1 and λ2 of similar colors) in a thin light guide plate, and diffracts the image light toward an eyeball EB by first and second diffraction units having wavelength selectivity, thereby displaying a wide angle-of-view image. In the display device of Comparative Example 3, the first diffraction unit has wavelength selectivity to λ1, and the second diffraction unit has wavelength selectivity to λ2. In this case, the left-half angle of view of the entire angle of view can be formed by the light of λ1 and the right-half angle of view can be formed by the light of λ2, and even if the light deflection width in the light guide plate is small (for example, even if the light guide plate is thin), the light having the same information can be incident on each diffraction unit once. As a result, according to the display device of Comparative Example 3, it is possible to display a wide angle-of-view image while suppressing crosstalk and an increase in size (see FIG. 3). To add more information, FIG. 3 is a graph illustrating a relationship between an angle of view of a display image and a thickness of a light guide plate, regarding a light guide plate using a normal diffraction unit and a light guide plate using diffraction units having selectivity. As illustrated in FIG. 3, in the light guide plate using the diffraction units having selectivity (for example, wavelength selectivity), it is possible to display an image of the same angle of view with a thinner plate thickness (for example, a plate thickness of about half) as compared with the normal light guide plate.

However, in the display device of Comparative Example 3, each diffraction unit having wavelength selectivity has a narrow wavelength band in which the diffraction unit has desired diffraction efficiency (see FIG. 2B), and for example, there is a possibility that the wavelength of light deviates from the wavelength band due to a change in the emission wavelength of the light source due to a temperature change or the like, and desired diffraction efficiency cannot be obtained. However, in the display device of Comparative Example 3, there is a possibility that a wide angle-of-view image cannot be stably displayed with high image quality.

Therefore, as a result of intensive studies, the inventors have developed a display device according to the present technology as a display device capable of stably displaying a wide angle-of-view image with high image quality while suppressing an increase in size and crosstalk.

### (Concept of Display Device According to Present Technology)

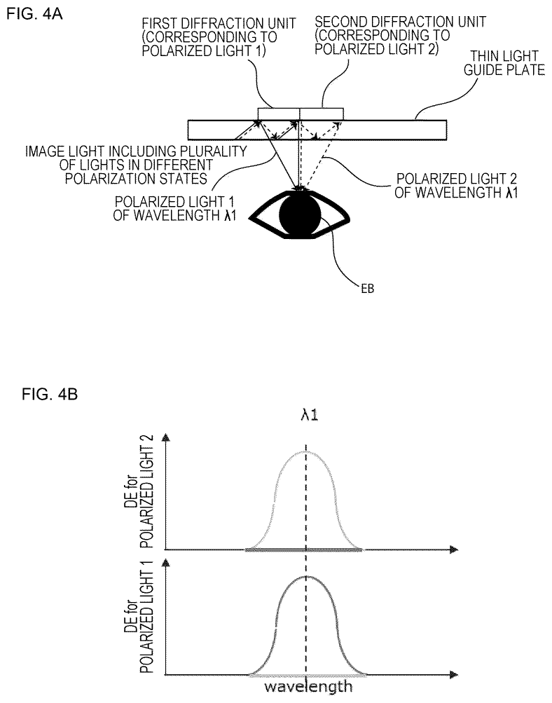

FIG. 4A is a schematic configuration diagram for explaining a concept of a display device according to the present technology. FIG. 4B illustrates graphs each illustrating a relationship between the wavelength of a polarized light and the diffraction efficiency of the corresponding diffraction unit in the display device according to the present technology. Notation DE on the vertical axis in FIG. 4B represents diffraction efficiency.

As an example, the display device according to the present technology illustrated in FIG. 4A displays a wide angle-of-view image by totally reflecting and propagating image light including a plurality of lights (for example, polarized light 1 and polarized light 2) having different polarization states in a thin light guide plate and diffracting the image light toward an eyeball EB by first and second diffraction units having polarization selectivity. In the display device of the present technology, the first diffraction unit has polarization selectivity for the polarized light 1, and the second diffraction unit has polarization selectivity for the polarized light 2. In this case, the left-half angle of view of the entire angle of view can be formed by the polarized light 1 and the right-half angle of view can be formed by the polarized light 2, and even if the light deflection width in the light guide plate is small (for example, even if the light guide plate is thin), light having the same information can be incident on each diffraction unit once. Moreover, in the display device according to the present technology, as illustrated in FIG. 4B, each diffraction unit has a wide wavelength band in which the diffraction unit has desired diffraction efficiency, and has high robustness against a change in wavelength of light. That is, the display device according to the present technology can stably display a high-quality image without being affected so much by a change in wavelength of light. As a result, according to the display device according to the present technology, it is possible to display a wide angle-of-view image while suppressing crosstalk and an increase in size.

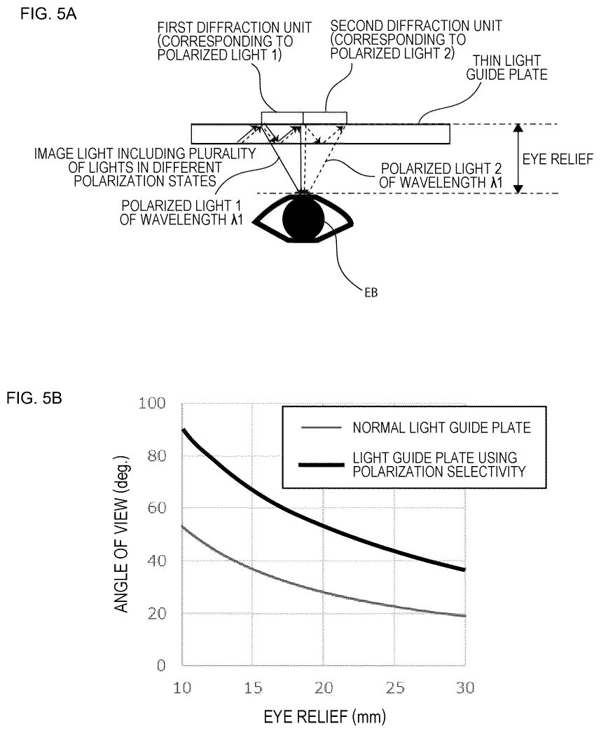

FIG. 5A is a schematic configuration diagram illustrating an eye relief of the display device according to the present technology. FIG. 5B is a graph illustrating the relationship between an eye relief and an angle of view of a display image, regarding the display device according to the present technology and a display device using a light guide plate provided with a normal diffraction unit. In the display device according to the present technology, as illustrated in FIGS. 5A and 5B, since the diffraction units having selectivity (for example, polarization selectivity) are used, it is possible to display an image having a wider angle of view with the same eye relief as compared with the light guide plate having the normal diffraction unit.

Hereinafter, some embodiments of the display device according to the present technology will be described in detail.

### 1. Display Device According to First Embodiment of Present Technology

A display device 10 according to a first embodiment of the present technology will be described with reference to the drawings. The display device 10 is used for providing a user with augmented reality (AR), virtual reality (VR), or the like, for example. Hereinafter, for convenience, in each of the drawings, description will be given on the assumption that a left side of a paper surface is left and a right side of the paper surface is right.

### <<Configuration of Display Device>>

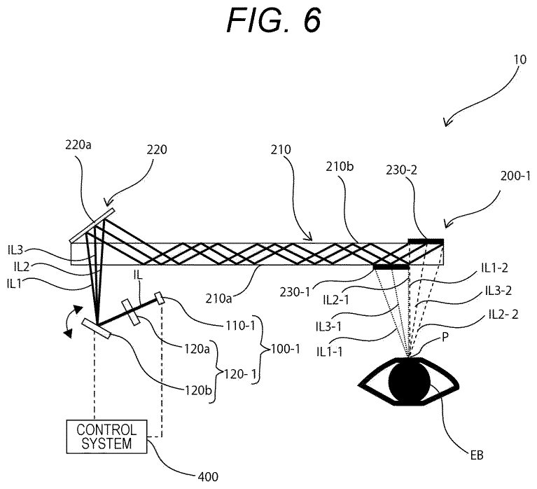

FIG. 6 is a diagram illustrating a configuration of the display device 10 according to the first embodiment of the present technology. The display device 10 is, for example, a head mounted display (HMD) used by being worn on the head of the user. The HMD is also called eyewear, for example. As an example, as illustrated in FIG. 6, the display device 10 includes an image light generation system 100-1 and a light guide system 200-1 that guides image light IL generated by the image light generation system 100-1 to an eyeball EB of the user. The display device 10 may further include a control system 400. As an example, the image light generation system 100-1 and the light guide system 200-1 are integrally provided in the same support structure (for example, a spectacle frame). The control system 400 may be provided integrally with the support structure or may be provided separately. Hereinafter, the description will be given on the premise that a spectacle frame as an example of the support structure is mounted on the head of the user.

### [Image Light Generation System]

As an example, the image light generation system 100-1 generates the image light IL including a plurality of lights (polarized lights) having different polarization states. As an example, the image light generation system 100-1 includes a light source unit 110-1 and an emission optical system 120-1.

### (Light Source Unit)

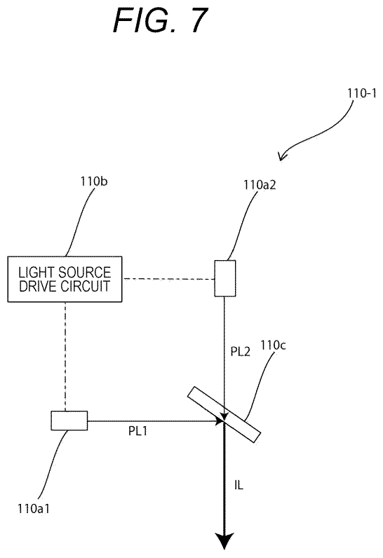

FIG. 7 is a diagram illustrating a configuration example of the light source unit 110-1 of the display device 10. As illustrated in FIG. 7 as an example, the light source unit 110-1 includes first and second light sources 110a1 and 110a2, a light source drive circuit 110b that drives each light source, and a light synthesizing element 110c that synthesizes light from each light source.

The first and second light sources 110a1 and 110a2 are arranged such that the optical paths of the emitted lights cross each other. The first light source 110a1 is a polarized light source that emits a first polarized light PL1. The second light source 110a2 is a polarized light source that emits a second polarized light PL2. The first and second polarized lights PL1 and PL2 have different polarization states (for example, polarization directions). Each light source is preferably a laser light source. Examples of the laser light source include a semiconductor laser such as a laser diode (LD) (edge emitting laser), a vertical cavity surface emitting laser (VCSEL) (surface emitting laser), or the like.

The first polarized light PL1 may be monochromatic light that is light of a single wavelength, or may be colored light that is light obtained by combining lights of a plurality of wavelengths. The second polarized light PL2 may be monochromatic light that is light of a single wavelength, or may be colored light that is light obtained by combining lights of a plurality of wavelengths.

The light source drive circuit 110b drives each light source on the basis of modulation data as described later transmitted from the control system 400. The light source drive circuit includes, for example, circuit elements such as a transistor and a capacitor.

The light synthesizing element 110c is arranged on an intersection of the optical paths of the first and second polarized lights PL1 and PL2 from the first and second light sources 110a1 and 110a2. The light synthesizing element 110c is a beam splitter (for example, a one-way mirror) that reflects one (for example, PL1) of the incident first and second polarized lights PL1 and PL2 and transmits the other (for example, PL2). The synthetic light obtained by synthesizing the first and second polarized lights PL1 and PL2 by the light synthesizing element 110c is the image light IL emitted from the light source unit 110-1. That is, the image light IL includes the first and second polarized lights PL1 and PL2.

### (Emission Optical System)

Returning to FIG. 6, the emission optical system 120-1 emits the image light IL from the light source unit 110-1 as image light (for example, image light IL1, IL2, and IL3) for each angle of view. The emission optical system 120-1 includes an optical element 120a and an optical deflector 120b.

The optical element 120a is, for example, a lens, a mirror, or the like. The optical element 120a converts the image light IL emitted from the light source unit 110-1 into substantially parallel light, convergent light, weak divergent light, or the like, and guides the light to the optical deflector 120b. Note that the optical element 120a is not essential, and may be omitted in some cases.

The optical deflector 120b is arranged on an optical path of the image light IL emitted from the light source unit 110-1 and passing through the optical element 120a. The optical deflector 120b deflects the incident image light IL to generate image light (for example, IL1, IL2, and IL3) for each angle of view. The optical deflector 120b includes a movable mirror movable about two axes, such as a MEMS mirror, a galvano mirror, a polygon mirror, or the like. Note that the optical deflector 120b may include a first movable mirror movable about one axis and a second movable mirror movable about the other axis. The optical deflector 120b is controlled by the control system 400. The control system 400 controls the optical deflector 120b in synchronization with the control of each light source.

### [Light Guide System]

As an example, the light guide system 200-1 includes a light guide plate 210, a relay optical system 220, and a plurality of diffraction units 230 (for example, 230-1 and 230-2).

### (Light Guide Plate)

The light guide plate 210 faces the eyeball EB. As an example, the image light generation system 100-1 is arranged on the eyeball EB side with respect to the light guide plate 210. The light guide plate 210 totally reflects and guides the image light IL generated by the image light generation system 100-1 and incident via the relay optical system 220. The light guide plate 210 includes, for example, a transparent, translucent, or opaque glass plate or resin plate. The light guide plate 210 may be a type (spectacle lens type) fitted into a spectacle frame as the support structure described above, or may be a type (combiner type) externally attached to the spectacle frame.

A transparent or translucent glass plate is used for the light guide plate 210, for example, in a case where augmented reality (AR) is provided to the user. An opaque glass plate is used for the light guide plate 210, for example, in a case where virtual reality (VR) is provided to the user.

The thickness of the light guide plate 210 is, for example, preferably 2 mm to 5 mm, more preferably 2.5 mm to 4.5 mm, and still more preferably 3 mm to 4 mm. Here, the thickness of the light guide plate 210 is set to 3.1 mm, for example.

The image light IL that has entered the light guide plate 210 via the relay optical system 220 propagates by being totally reflected repeatedly in the light guide plate 210. That is, the image light IL propagates zigzag in the light guide plate 210.

### (Relay Optical System)

As an example, the relay optical system 220 includes a turning mirror 220a that turns the image light IL emitted from the image light generation system 100-1 and transmitted through one end portion (left end portion) of the light guide plate 210 toward the light guide plate 210. The position and posture of the turning mirror 220a with respect to the light guide plate 210 are set such that the incident image light IL enters the light guide plate 210 at an incident angle at which the image light IL is totally reflected by the light guide plate 210. As an example, the turning mirror 220a is provided integrally with the light guide plate 210.

### (Diffraction Unit)

The light guide system 200-1 includes the plurality of diffraction units 230 (for example, the first and second diffraction units 230-1 and 230-2). In the image light IL, at least light in a corresponding polarization state is incident on each diffraction unit 230. Each diffraction unit 230 diffracts the incident light in the corresponding polarization state toward the eyeball EB. As an example, the first and second diffraction units 230-1 and 230-2 are provided at the other end portion (right end portion, end portion facing eyeball EB) of the light guide plate 210. The first and second diffraction units 230-1 and 230-2 preferably have polarization selectivity for lights in polarization states different from each other. As each diffraction unit 230, for example, a holographic optical element (HOE), a diffractive optical element (DOE), metamaterial, or the like can be used. For example, each diffraction unit 230 may be formed by processing a surface of the light guide plate 210, or may be attached to a surface of the light guide plate 210.

At least two (for example, all) diffraction units 230 among the plurality of diffraction units 230 correspond to different polarization states among the polarization states of the plurality of lights. Specifically, the first diffraction unit 230-1 has desired (high) diffraction efficiency for the first polarized light PL1 and has little or no diffraction efficiency for the second polarized light PL2. The second diffraction unit 230-2 has desired (high) diffraction efficiency for the second polarized light PL2 and has little or no diffraction efficiency for the first polarized light PL1. Here, the sizes of the diffraction units 230 are the same, but may be different.

The plurality of diffraction units 230 may each cause light in the corresponding polarization state to be incident on the eyeball from directions different from each other. That is, the plurality of diffraction units 230 causes the incident image light IL to be incident on the eyeball EB at a wide angle of view. Specifically, the first and second diffraction units 230-1 and 230-2 are arranged apart from each other at least in the in-plane direction of the light guide plate 210 (specifically, the propagation direction (left-right direction) of the image light IL in the light guide plate 210). Moreover, as an example, the first diffraction unit 230-1 is provided at a location corresponding to a total reflection position of the image light IL on a surface 210a of the light guide plate 210 on the eyeball EB side, and the second diffraction unit 230-2 is provided at a location corresponding to a total reflection position of the image light IL on a surface 210b of the light guide plate 210 on the side opposite to the eyeball EB side. Here, the first and second diffraction units 230-1 and 230-2 are provided at locations on the light guide plate 210 corresponding to total reflection positions where the image light IL is incident in succession. As an example, the positions of the right end of the first diffraction unit 230-1 and the left end of the second diffraction unit 230-2 in the in-plane direction of the light guide plate 210 substantially coincide with each other.

At least part of the image light IL propagated from the left side to the right side in the light guide plate 210 is incident on the first and second diffraction units 230-1 and 230-2 in this order. Most of the first polarized light PL1 of the image light IL incident on the first diffraction unit 230-1 is selectively diffracted by the first diffraction unit 230-1 and is incident on the eyeball EB, and the rest including the second polarized light PL2 is totally reflected by the light guide plate 210 toward the second diffraction unit 230-2. Most of the second polarized light PL2 of the image light IL incident on the second diffraction unit 230-2 is selectively diffracted by the second diffraction unit 230-2 and is incident on the eyeball EB.

In each diffraction unit 230, diffraction power for diffracting light in the corresponding polarization state is distributed in the in-plane direction. The diffraction direction of the light in the corresponding polarization state by each diffraction unit 230 is a direction that does not satisfy the total reflection condition in the light guide plate 210. Therefore, the light in the corresponding polarization state diffracted by each diffraction unit 230 is not totally reflected by the light guide plate 210 and is taken out to the outside of the light guide plate 210.

For example, the light diffracted at the left end portion of the first diffraction unit 230-1 is extracted to the outside of the light guide plate 210 so as to form the leftmost angle of view of the entire angle of view. For example, the light diffracted at the right end portion of the first diffraction unit 230-1 is extracted to the outside of the light guide plate 210 so as to form the central angle of view of the entire angle of view. For example, the light diffracted at the left end portion of the second diffraction unit 230-2 is extracted to the outside of the light guide plate 210 so as to form the central angle of view of the entire angle of view. The light diffracted at the right end portion of the second diffraction unit 230-2 is extracted to the outside of the light guide plate 210 so as to form the rightmost angle of view of the entire angle of view.

That is, the first diffraction unit 230-1 forms light for each angle of view of the left-half of the entire angle of view of the image light IL with which the eyeball EB is irradiated. The second diffraction unit 230-2 forms light for each angle of view of the right-half of the entire angle of view of the image light IL with which the eyeball EB irradiated.

The diffraction power distribution is set such that each of the first and second diffraction units 230-1 and 230-2 diffracts a plurality of lights of the image light IL, the plurality of lights being incident on different locations, toward the same location P (focus point P) on the eyeball EB.

### (Control System)

The control system 400 integrally controls the entire display device 10. The control system 400 is implemented by, for example, hardware such as a CPU, a chip set, and the like. The control system 400 generates modulation data on the basis of image data input from an external device or input via a network, and transmits the modulation data to the light source drive circuit 110b (see FIG. 7).

### <<Operation of Display Device>>

Hereinafter, the operation of the display device 10 according to the first embodiment of the present technology will be described. Here, a case where the diffraction efficiency of each diffraction unit 230 for the light in the corresponding polarization state is 100% will be described as an example. First, the operation common to each image light IL will be described. The image light IL (FIG. 6 illustrates three image lights IL1, IL2, and IL3) emitted from the image light generation system 100-1 enters the light guide plate 210 via the relay optical system 220 so as to satisfy the total reflection condition. The image light IL propagated by being totally reflected repeatedly in the light guide plate 210 is incident on the first diffraction unit 230-1. The first polarized light PL1 included in the image light IL incident on the first diffraction unit 230-1 is diffracted by the first diffraction unit 230-1 toward the location P on the eyeball EB, and the second polarized light PL2 is totally reflected by the light guide plate 210 toward the second diffraction unit 230-2. The second polarized light PL2 incident on the second diffraction unit 230-2 is diffracted toward the location P on the eyeball EB by the second diffraction unit 230-2.

Next, the operation of each of the image lights IL1 to IL3 will be described. The image light IL1 emitted from the image light generation system 100-1 and forms the left angle of view of the entire angle of view enters the light guide plate 210 via the relay optical system 220 so as to satisfy the total reflection condition. The image light IL1 propagated by being totally reflected repeatedly in the light guide plate 210 is incident on the left end of the first diffraction unit 230-1. In the image light IL1 incident on the left end of the first diffraction unit 230-1, the image light IL1-1 including the first polarized light PL1 is diffracted toward the location P on the eyeball EB so as to form the left angle of view of the entire angle of view by the first diffraction unit 230-1, and the image light IL1-2 including the second polarized light PL2 is totally reflected by the light guide plate 210 toward the left end of the second diffraction unit 230-2. The image light IL1-2 incident on the left end of the second diffraction unit 230-2 is diffracted toward the location P on the eyeball EB so as to form the central angle of view of the entire angle of view by the second diffraction unit 230-2.

The image light IL2 emitted from the image light generation system 100-1 and forms the right angle of view of the entire angle of view enters the light guide plate 210 via the relay optical system 220 so as to satisfy the total reflection condition. The image light IL2 propagated by being totally reflected repeatedly in the light guide plate 210 is incident on the right end of the first diffraction unit 230-1. In the image light IL2 incident on the right end of the first diffraction unit 230-1, the image light IL2-1 including the first polarized light PL1 is diffracted toward the location P on the eyeball EB so as to form the central angle of view of the entire angle of view, and the image light IL2-2 including the second polarized light PL2 is totally reflected by the light guide plate 210 toward the right end of the second diffraction unit 230-2. The image light IL2-2 incident on the right end of the second diffraction unit 230-2 is diffracted toward the location P on the eyeball EB so as to form the right angle of view of the entire angle of view.

The image light IL3 emitted from the image light generation system 100-1 and forms the central angle of view of the entire angle of view enters the light guide plate 210 via the relay optical system 220 so as to satisfy the total reflection condition. The image light IL3 propagated by being totally reflected repeatedly in the light guide plate 210 is incident on the center of the first diffraction unit 230-1. In the image light IL3 incident on the center of the first diffraction unit 230-1, the image light IL3-1 including the first polarized light PL1 is diffracted toward the location P on the eyeball EB so as to form the intermediate angle of view between the left angle of view and the central angle of view of the entire angle of view, and the image light IL3-2 including the second polarized light PL2 is totally reflected by the light guide plate 210 toward the center of the second diffraction unit 230-2. The image light IL3-2 incident on the center of the second diffraction unit 230-2 is diffracted toward the location P on the eyeball EB so as to form the intermediate angle of view between the right angle of view and the central angle of view of the entire angle of view.

### 2. Display Device According to Second Embodiment of Present Technology

Hereinafter, a display device according to a second embodiment of the present technology will be described in detail with some examples.

### (Example 1)

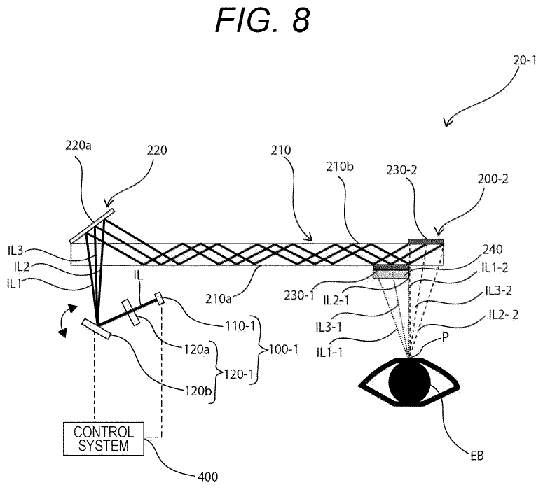

FIG. 8 is a diagram illustrating a configuration of a display device 20-1 according to Example 1 of the second embodiment of the present technology. The display device 20-1 has a configuration substantially similar to that of the display device 10 according to the first embodiment except that first and second diffraction units 230-1 and 230-2 have circular polarization selectivity and a light guide system 200-2 has a retardation film 240.

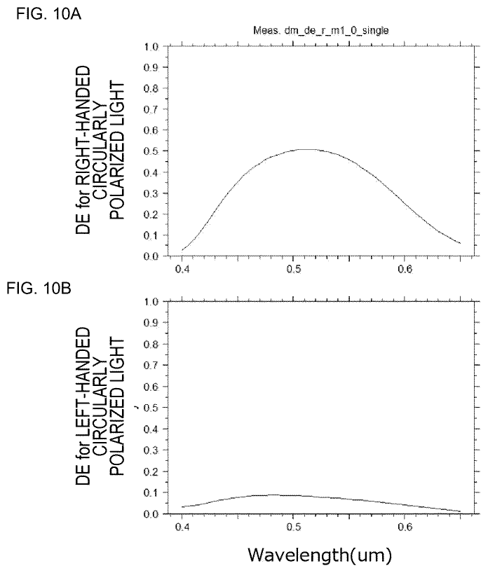

In the display device 20-1, as an example, a cholesteric liquid crystal element having cholesteric liquid crystal is used for each diffraction unit 230. This cholesteric liquid crystal element has a characteristic of selectively acting on circularly polarized light. That is, the cholesteric liquid crystal element has effective diffraction efficiency for one of clockwise circularly polarized light and counterclockwise circularly polarized light (see, for example, FIGS. 10A and 10B). Here, the first diffraction unit 230-1 has effective diffraction efficiency for clockwise circularly polarized light and does not have effective diffraction efficiency for counterclockwise circularly polarized light. The second diffraction unit 230-2 has effective diffraction efficiency for counterclockwise circularly polarized light and does not have effective diffraction efficiency for clockwise circularly polarized light.

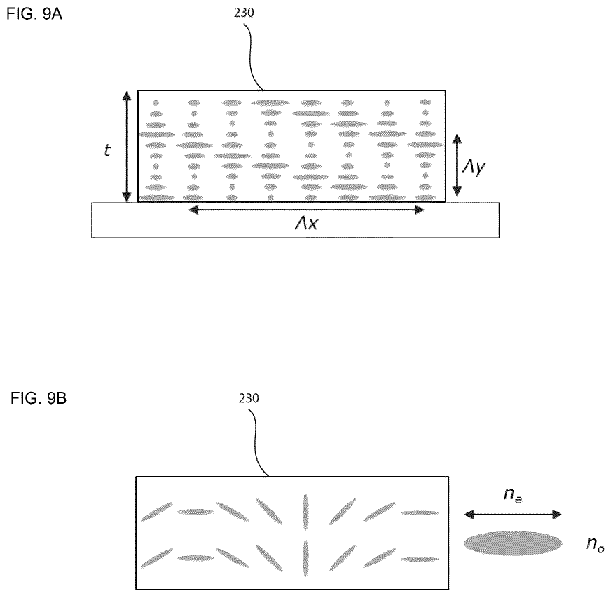

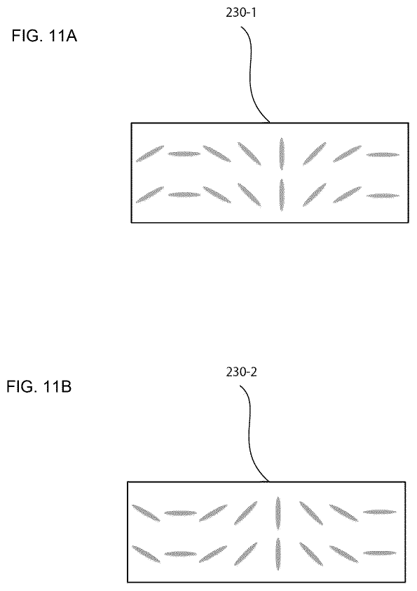

FIGS. 9A and 9B are a side view and a plan view, respectively, of Configuration Example 1 of the diffraction unit 230. FIGS. 10A and 10B are diagrams illustrating circular polarization selectivity of Configuration Example 1 of the diffraction unit. FIGS. 11A and 11B are views illustrating arrays of liquid crystal molecules in plan view of the first diffraction unit 230-1 and the second diffraction unit 230-2, respectively.

As the diffraction unit 230, the cholesteric liquid crystal element has, for example, a periodic structure in which the cholesteric liquid crystal element has periods in the x direction and the y direction in FIG. 9A, and as illustrated in FIG. 9B, the liquid crystal molecules rotate by 180° in their periods in plan view. In the periodic structures of the first and second diffraction units 230-1 and 230-2, the rotation directions of the liquid crystal molecules are opposite to each other (see FIGS. 11A and 11B). Here, a periodic structure suitable for propagating through a light guide plate 210 having a refractive index of 1.6 at a total reflection angle of 55° and diffracting at 0° (center of the angle of view) is representatively illustrated. In FIG. 9A, t represents the thickness of the cholesteric liquid crystal element. In FIG. 9B, ne represents the extraordinary ray refractive index (for example, 1.7) of the cholesteric liquid crystal element, and no represents the ordinary ray refractive index (for example, 1.5) of the cholesteric liquid crystal element.

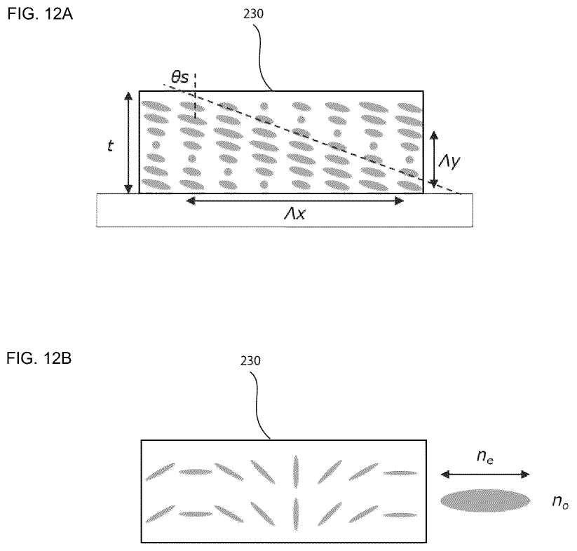

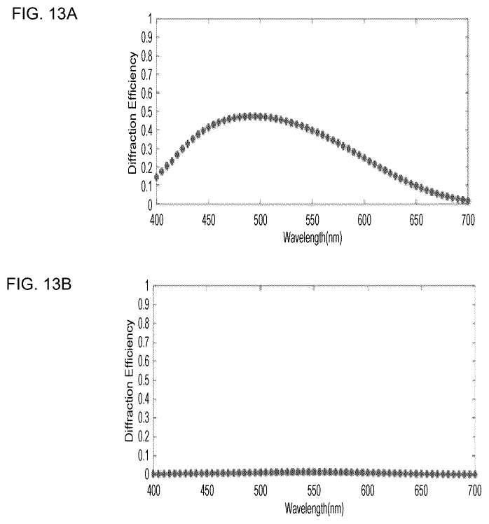

FIGS. 12A and 12B are a side view and a plan view, respectively, of Configuration Example 2 of the diffraction unit 230. FIGS. 13A and 13B are diagrams illustrating clockwise circular polarization selectivity and counterclockwise circular polarization selectivity of Configuration Example 2 of the diffraction unit 230. Configuration Example 2 of the diffraction unit 230 has a structure in which liquid crystal molecules rotate in the xy plane (structure inclined by an angle θs with respect to the y direction). With this structure, in each diffraction unit 230, selectivity for the corresponding circularly polarized light can be made stronger, and stray light can be hardly generated. Note that FIG. 13A illustrates diffraction efficiency for each wavelength of circularly polarized light corresponding to Configuration Example 2 of the diffraction unit 230, and FIG. 13B illustrates diffraction efficiency for each wavelength of circularly polarized light not corresponding to Configuration Example 2 of the diffraction unit 230.

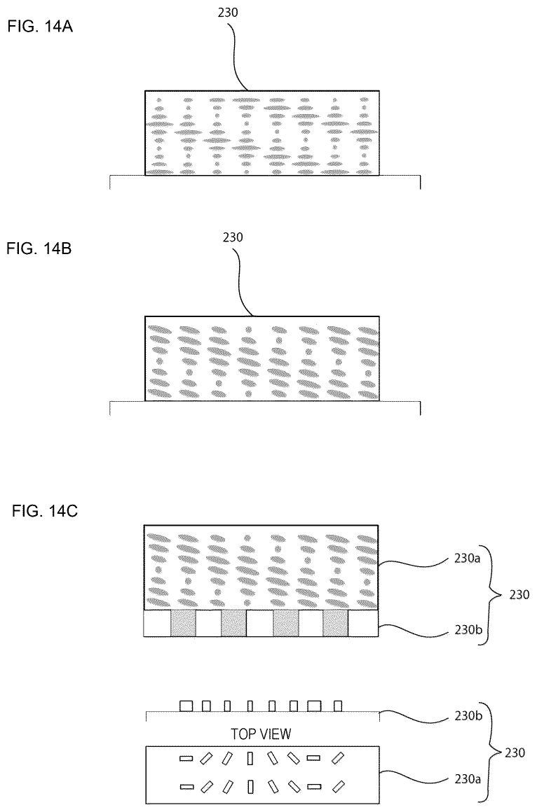

FIGS. 14A to 14C are views illustrating Configuration Examples 1 to 3 of the diffraction unit 230, respectively. The upper view of FIG. 14C is a side view of Configuration Example 3 of the diffraction unit 230. The lower view of FIG. 14C is a plan view of Configuration Example 3 of the diffraction unit 230. Configuration Example 3 of the diffraction unit 230 illustrated in FIG. 14C has a structure in which a cholesteric liquid crystal element 230a and a diffraction element 230b in which materials having different refractive indexes are arranged at, for example, equal intervals in an in-plane direction are stacked. In Configuration Example 3, in each diffraction unit, selectivity for the corresponding circularly polarized light can be made further stronger, and stray light can be hardly generated.

Meanwhile, when the image light propagates in the light guide plate, a different phase difference is given to the S-polarized component and the P-polarized component in the circularly polarized light every time total reflection occurs. Therefore, there is a problem in which the polarization state changes every time total reflection occurs. Therefore, it is desirable to select the polarization state of light emitted from a light source unit such that clockwise circularly polarized light and counterclockwise circularly polarized light are incident on the first diffraction unit 230-1 in consideration of the phase difference provided until the light is incident on each diffraction unit 230 after the total reflection. Furthermore, since total reflection occurs even after the light has passed through the first diffraction unit 230-1, it is preferable to arrange the retardation film 240 for adjusting the polarization state on the optical path of the image light IL so that at least one of the clockwise circularly polarized light or the counterclockwise circularly polarized light is continuously incident on the second diffraction unit 230-2. For example, the retardation film 240 may be stacked and provided on the diffraction unit 230 or may be provided at a total reflection position of the image light IL on the light guide plate 210. The number and arrangement position of the retardation film 240 can be appropriately changed.

Returning to FIG. 8, the display device 20-1 according to Example 1 of the second embodiment has a configuration in which each of the plurality of diffraction units 230 has circular polarization selectivity, and the first and second circularly polarized lights having different (mutually opposite) polarization directions are incident on the first and second diffraction units 230-1 and 230-2, respectively. One of the first and second circularly polarized lights is clockwise circularly polarized light, and the other is counterclockwise circularly polarized light. Specifically, the first diffraction unit 230-1 has polarization selectivity (effective diffraction efficiency) for the first circularly polarized light and does not have polarization selectivity (effective diffraction efficiency) for the second circularly polarized light. The second diffraction unit 230-2 has polarization selectivity (effective diffraction efficiency) for the second circularly polarized light and does not have polarization selectivity (effective diffraction efficiency) for the first circularly polarized light.

For example, in the light source unit 110-1, two linearly polarized lights (for example, first and second polarized lights PL1 and PL2) emitted from first and second light sources 110a1 and 110a2 and having polarization directions orthogonal to each other may be converted into two circularly polarized lights having polarization directions opposite to each other through a quarter-wave plate, and then optical paths of the two circularly polarized lights may be synthesized to generate the image light IL. For example, linearly polarized light (for example, one of the first and second polarized lights PL1 and PL2) emitted from one of the first and second light sources 110a1 and 110a2 may be converted into the first circularly polarized light by a quarter-wave plate, and an optical path of the first circularly polarized light and an optical path of the second circularly polarized light (for example, the other of the first and second polarized lights PL1 and PL2) emitted from the other may be synthesized to generate the image light IL.

In the display device 20-1 according to Example 1 of the second embodiment, each of the first and second diffraction units 230-1 and 230-2 preferably has a cholesteric liquid crystal element. In this case, the rotation direction of the liquid crystal molecules in the cholesteric liquid crystal element of the first diffraction unit 230-1 is preferably opposite to the rotation direction of the liquid crystal molecules in the cholesteric liquid crystal element of the second diffraction unit 230-2. Moreover, in the cholesteric liquid crystal element of each of the first and second diffraction units 230-1 and 230-2, the alignment direction of liquid crystal molecules may be inclined with respect to the thickness direction.

In the display device 20-1, in the light guide system 200-2, the retardation film 240 is provided on the surface of the first diffraction unit 230-1 on the eyeball EB side. Here, the phase difference of the second polarized light PL2 included in the image light IL is adjusted by the retardation film 240 such that at least light (for example, clockwise or counterclockwise circularly polarized light) in a corresponding polarization state is incident on the second diffraction unit 230-1.

### (Example 2)

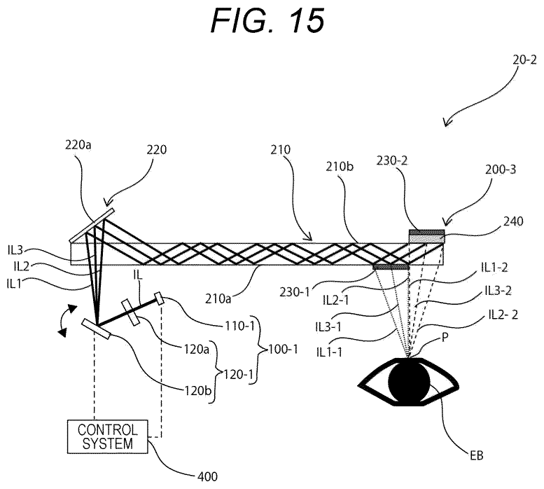

FIG. 15 is a diagram illustrating a configuration of a display device 20-2 according to Example 2 of the second embodiment of the present technology. In the display device 20-2, in a light guide system 200-3, the retardation film 240 is provided between the second diffraction unit 230-2 and the light guide plate 210. Here, the phase difference of the second polarized light PL2 is adjusted by the retardation film 240 such that at least light (for example, clockwise or counterclockwise circularly polarized light) in a corresponding polarization state is incident on the second diffraction unit 230-2.

### (Example 3)

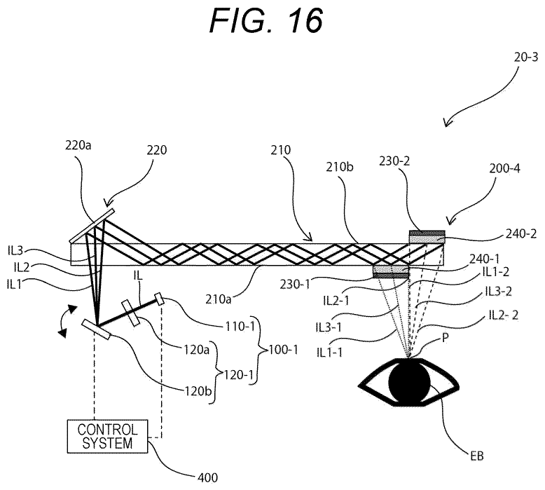

FIG. 16 is a diagram illustrating a configuration of a display device 20-3 according to Example 3 of the second embodiment of the present technology. In the display device 20-3, in a light guide system 200-4, a first retardation film 240-1 is provided between the first diffraction unit 230-1 and the light guide plate 210, and a second retardation film 240-2 is provided between the second diffraction unit 230-2 and the light guide plate 210. Here, the phase difference of the first polarized light PL1 included in the image light IL is adjusted by the first retardation film 240-1 such that at least light (for example, one of clockwise circularly polarized light and counterclockwise circularly polarized light) in a corresponding polarization state is incident on the first diffraction unit 230-1. Here, the phase difference of the second polarized light PL2 is adjusted by the first and second retardation films 240-1 and 240-2 such that at least light (for example, the other of the clockwise circularly polarized light and the counterclockwise circularly polarized light) in a corresponding polarization state is incident.
(Example 4)

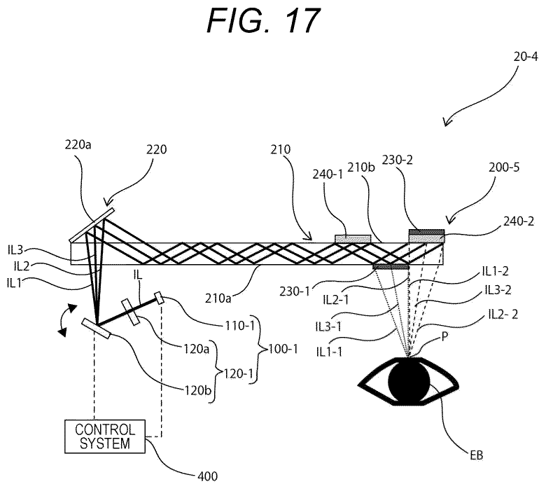

FIG. 17 is a diagram illustrating a configuration of a display device 20-4 according to Example 4 of the second embodiment of the present technology. In the display device 20-4, in a light guide system 200-5, the first retardation film 240-1 is provided at a total reflection position before (for example, immediately before) the total reflection position at which the first diffraction unit 230-1 of the light guide plate 210 is provided, and the second retardation film 240-2 is provided between the second diffraction unit 230-2 and the light guide plate 210. Here, the phase difference of the first polarized light PL1 included in the image light IL is adjusted by the first retardation film 240-1 such that at least light (for example, one of clockwise circularly polarized light and counterclockwise circularly polarized light) in a corresponding polarization state is incident on the first diffraction unit 230-1. Here, the phase difference of the second polarized light PL2 is adjusted by the first and second retardation films 240-1 and 240-2 such that at least light (for example, the other of the clockwise circularly polarized light and the counterclockwise circularly polarized light) in a corresponding polarization state is incident.

### (Example 5)

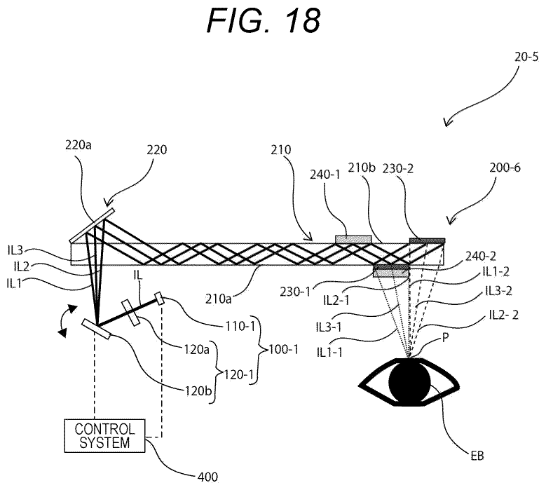

FIG. 18 is a diagram illustrating a configuration of a display device 20-5 according to Example 5 of the second embodiment of the present technology. In the display device 20-5, in a light guide system 200-6, the first retardation film 240-1 is provided at a total reflection position before (for example, immediately before) the total reflection position at which the first diffraction unit 230-1 of the light guide plate 210 is provided, and the second retardation film 240-2 is provided on a surface of the first diffraction unit 230-1 on the eyeball EB side. Here, the phase difference of the first polarized light PL1 included in the image light IL is adjusted by the first retardation film 240-1 such that at least light (for example, one of clockwise circularly polarized light and counterclockwise circularly polarized light) in a corresponding polarization state is incident on the first diffraction unit 230-1. The phase difference of the second polarized light PL2 is adjusted by the second retardation film 240-2 such that at least light (for example, the other of the clockwise circularly polarized light and the counterclockwise circularly polarized light) in a corresponding polarization state is incident on the second diffraction unit 230-2.

### (Example 6)

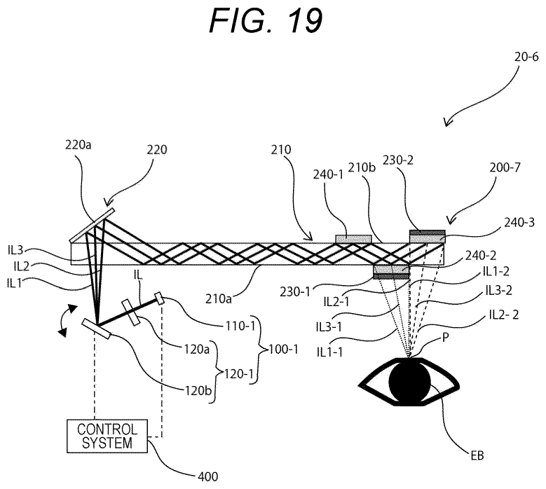

FIG. 19 is a diagram illustrating a configuration of a display device 20-6 according to Example 6 of the second embodiment of the present technology. In the display device 20-6, in a light guide system 200-7, the first retardation film 240-1 is provided at a total reflection position before (for example, immediately before) the total reflection position at which the first diffraction unit 230-1 of the light guide plate 210 is provided, the second retardation film 240-2 is provided on the surface of the first diffraction unit 230-1 on the eyeball EB side, and a third retardation film 240-3 is provided between the second diffraction unit 230-2 and the light guide plate 210. Here, the phase difference of the first polarized light PL1 included in the image light IL is adjusted by the first and second retardation films 240-1 and 240-2 such that at least light (for example, one of clockwise circularly polarized light and counterclockwise circularly polarized light) in a corresponding polarization state is incident on the first diffraction unit 230-1. The phase difference of the second polarized light PL2 is adjusted by the first to third retardation films 240-1, 240-2, and 240-3 such that at least light (for example, the other of the clockwise circularly polarized light and the counterclockwise circularly polarized light) in a corresponding polarization state is incident on the second diffraction unit 230-2.

### 3. Display Device According to Third Embodiment of Present Technology

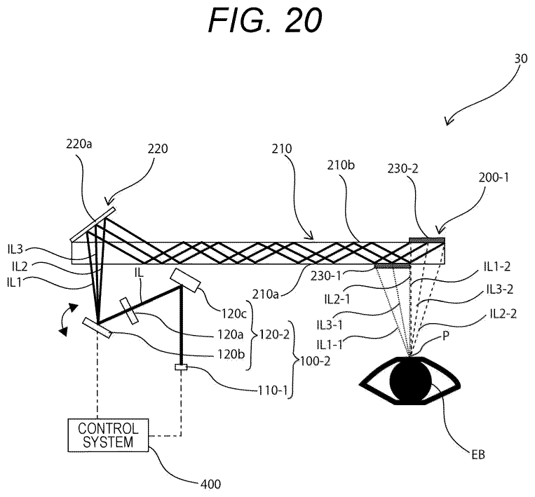

Hereinafter, a display device according to a third embodiment of the present technology will be described with reference to the drawings. FIG. 20 is a diagram illustrating a configuration of a display device 30 according to the third embodiment of the present technology. The display device 30 has a configuration similar to that of the display device 10 according to the first embodiment except that an emission optical system 120-2 of an image light generation system 100-2 includes another diffraction unit 120c that corrects chromatic aberration of a diffraction unit 230.

The other diffraction unit 120c is arranged on an optical path of image light IL between a light source unit 110-1 and an optical deflector 120b, and corrects chromatic aberration of at least one of a first diffraction unit 230-1 or a second diffraction unit 230-2.

According to the display device 30 described above, it is possible to display an image with higher image quality.

### 4. Display Device According to Fourth Embodiment of Present Technology

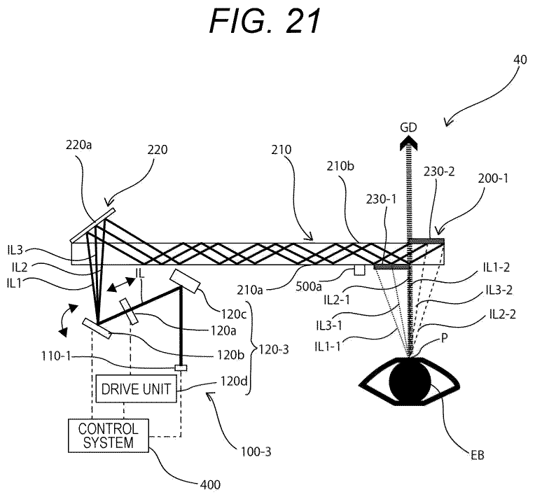

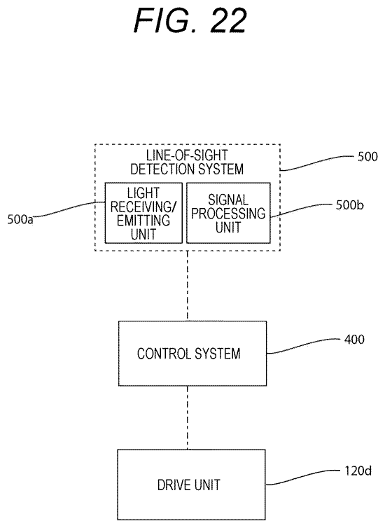

Hereinafter, a display device according to a fourth embodiment of the present technology will be described with reference to the drawings. FIG. 21 is a diagram illustrating a configuration of a display device 40 according to the fourth embodiment of the present technology. FIG. 22 is a block diagram illustrating functions of the display device 40 according to the fourth embodiment of the present technology.

The display device 40 has a configuration substantially similar to that of the display device 30 according to the third embodiment except that a line-of-sight detection system 500 (see FIG. 22) is provided and that an emission optical system 120-3 of an image light generation system 100-3 includes a drive unit 120d (optical element control unit) capable of moving an optical element 120a in the optical axis direction thereof.

Examples of the drive unit 120d include a linear motor, a combination of a rack-and-pinion mechanism and a drive source (for example, a motor), a combination of a ball screw mechanism and a drive source (for example, a motor), and the like.

As illustrated in FIG. 22, the line-of-sight detection system 500 detects the direction of a line-of-sight that is the direction of the eyeball EB, and outputs the detection result to a control system 400. The line-of-sight detection system 500 includes a light receiving/emitting unit 500a (see FIGS. 21 and 22) and a signal processing unit 500b (see FIG. 22). The light receiving/emitting unit 500a includes a light emitting element that irradiates the eyeball EB with invisible light (for example, infrared light) and a light receiving element (for example, a quadrant photodiode (PD), an image sensor, or the like) in which a plurality of light receiving units is two-dimensionally arranged. The signal processing unit 500b processes output signals of the plurality of light receiving units of the light receiving element and calculates the direction of the line-of-sight.

The control system 400 controls the drive unit 120d on the basis of the detection result of the line-of-sight detection system 500. Specifically, the control system 400 controls the drive unit 120d to move the optical element 120a in the optical axis direction thereof according to a line-of-sight direction GD (also referred to as a gaze direction GD), which is the direction of the eyeball EB, thereby controlling the divergence angle and/or the beam shape of image light IL.

For example, as illustrated in FIG. 21, first, the position of the optical element 120a at which the divergence angle and the beam shape of the image light (for example, IL2-1 and IL1-2) incident on the eyeball EB along the gaze direction GD when the gaze direction GD is toward the front are appropriate is set as a reference position.

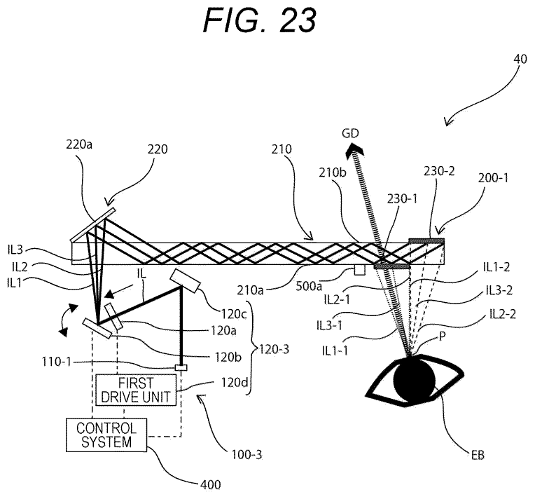

For example, as illustrated in FIG. 23, when the gaze direction GD is directed leftward, the control system 400 controls the drive unit 120d to move the optical element 120a to a position which is on an optical deflector 120b side with respect to the reference position and at which the divergence angle and the beam shape of image light (for example, IL1-1 and IL3-1) incident on the eyeball EB along the gaze direction GD are appropriate.

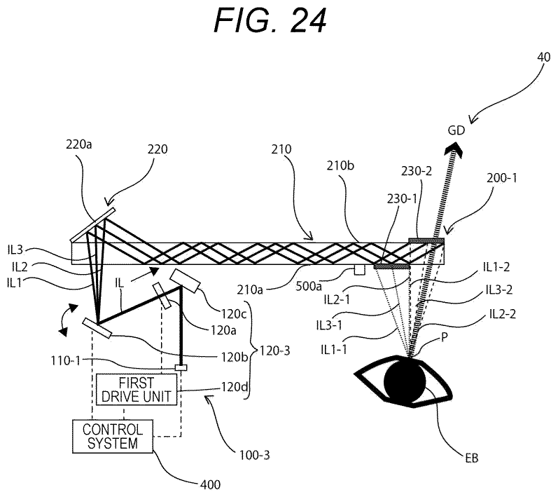

For example, as illustrated in FIG. 24, when the gaze direction GD is directed rightward, the control system 400 controls the drive unit 120d to move the optical element 120a to a position which is on an another diffraction unit 120c side with respect to the reference position and at which the divergence angle and the beam shape of image light (for example, IL2-2 and IL3-2) incident on the eyeball EB along the gaze direction GD are appropriate.

According to the display device 40 described above, it is possible to display an image with good visibility regardless of the line-of-sight direction of the user.

In the display device 40 according to the fourth embodiment, the optical element control unit moves the optical element 120a in the optical axis direction thereof, but the optical element control unit is not limited thereto. For example, the optical element control unit may change the focal length of the optical element by changing the surface shape of the optical element whose surface shape is variable, or may change the focal length of the optical element by controlling the optical element including a material such as liquid crystal. Also in these cases, effects similar to those of the display device 40 can be obtained.

### 5. Display Device According to Fifth Embodiment of Present Technology

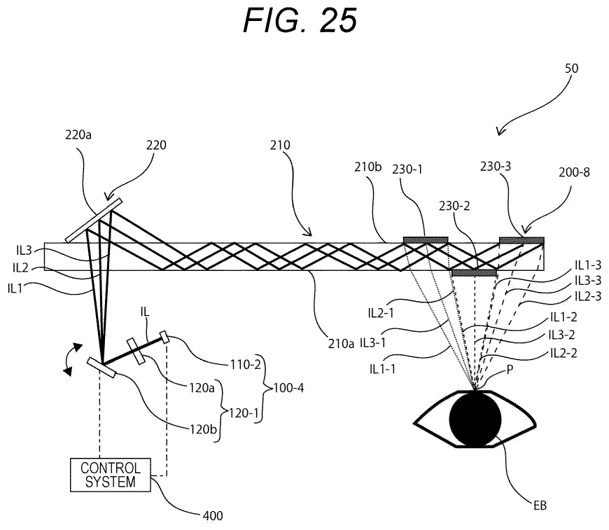

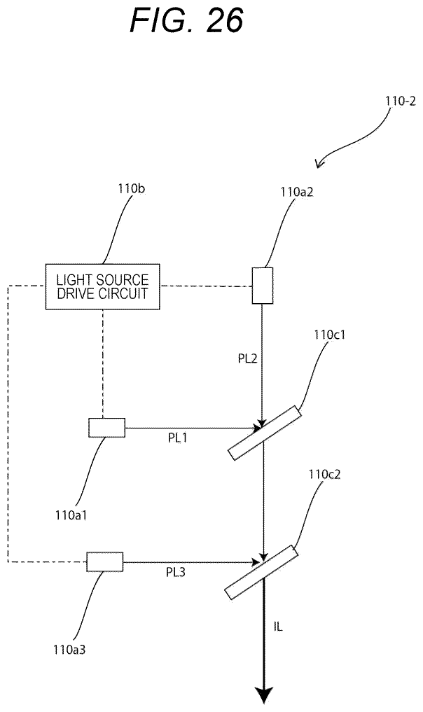

Hereinafter, a display device according to a fifth embodiment of the present technology will be described with reference to the drawings. FIG. 25 is a diagram illustrating a configuration of a display device 50 according to the fifth embodiment of the present technology. FIG. 26 is a diagram illustrating a configuration example of a light source unit 110-2 of the display device 50.

The display device 50 has a configuration substantially similar to that of the display device 10 according to the first embodiment except that a light guide system 200-8 includes three diffraction units 230 (for example, first to third diffraction units 230-1, 230-2, and 230-3) (see FIG. 25) and that image light IL includes three polarized lights (for example, first to third polarized lights PL1, PL2, and PL3) having different polarization states (see FIG. 26).

In the light guide system 200-8, as illustrated in FIG. 25 as an example, the first and third diffraction units 230-1 and 230-3 are provided on a surface 210b on the side opposite to an eyeball EB side of a light guide plate 210 to be separated from each other in the left-right direction, and the second diffraction unit 230-2 is provided on a surface 210a on the eyeball EB side of the light guide plate 210 at a location sandwiched between the first and third diffraction units 230-1 and 230-3 when viewed from the thickness direction of the light guide plate 210. Here, among three continuous total reflection positions on the light guide plate 210, the first diffraction unit 230-1 is provided at the first total reflection position, the second diffraction unit 230-2 is provided at the next total reflection position, and the third diffraction unit 230-3 is provided at the last total reflection position.

As illustrated in FIG. 26 as an example, a light source unit 110-2 of an image light generation system 100-4 includes a first light source 110a1 that emits the first polarized light PL1, a second light source 110a2 that emits the second polarized light PL2, and a third light source 110a3 that emits the third polarized light PL3. Each light source is driven (turned on/off) by a light source drive circuit 110b. A first beam splitter 110c1 (for example, a one-way mirror) is arranged at an intersection of an optical path of the first polarized light PL1 and an optical path of the second polarized light PL2. A second beam splitter 110c2 (for example, a one-way mirror) is arranged at an intersection of an optical path of synthetic light of the first and second polarized lights PL1 and PL2 and an optical path of the third polarized light PL3. The synthetic light of the first to third polarized lights PL1 to PL3 is emitted from the second beam splitter 110c2 as the image light IL.

Returning to FIG. 25, in the light guide system 200-8, the first diffraction unit 230-1 has polarization selectivity for the first polarized light PL1, the second diffraction unit 230-2 has polarization selectivity for the second polarized light PL2, and the third diffraction unit 230-3 has polarization selectivity for the third polarized light PL3.

Hereinafter, the operation of the display device 50 will be described. Here, a case where the diffraction efficiency of each diffraction unit 230 for the light in the corresponding polarization state is 100% will be described as an example. In the display device 50, the image light IL (for example, the image light IL1, IL2 and IL3) emitted from the image light generation system 100-4 is incident on the light guide plate 210 via a relay optical system 220, propagated through the light guide plate 210 while being totally reflected repeatedly, and then incident on the first diffraction unit 230-1.

In the image light IL1 incident on the first diffraction unit 230-1, image light IL1-1 including the first polarized light PL1 is diffracted toward an eyeball EB so as to form the leftmost angle of view of the entire angle of view, and the second and third polarized lights PL2 and PL3 are totally reflected by the light guide plate 210 toward the second diffraction unit 230-2. In the image light IL2 incident on the first diffraction unit 230-1, image light IL2-1 including the first polarized light PL1 is diffracted toward the eyeball EB so as to form a first intermediate angle of view on the left side of the entire angle of view, and the second and third polarized lights PL2 and PL3 are totally reflected by the light guide plate 210 toward the second diffraction unit 230-2. In the image light IL3 incident on the first diffraction unit 230-1, image light IL3-1 including the first polarized light PL1 is diffracted toward the eyeball EB so as to form a second intermediate angle of view on the left side between the leftmost side of the entire angle of view and the first intermediate angle of view, and the second and third polarized lights PL2 and PL3 are totally reflected by the light guide plate 210 toward the second diffraction unit 230-2.

In the image light IL1 incident on the second diffraction unit 230-2, image light IL1-2 including the second polarized light PL2 is diffracted toward the eyeball EB so as to form a first intermediate angle of view on the left side of the entire angle of view, and the third polarized light PL3 is totally reflected by the light guide plate 210 toward the third diffraction unit 230-3. In the image light IL2 incident on the second diffraction unit 230-2, image light IL2-2 including the second polarized light PL2 is diffracted toward the eyeball EB so as to form a first intermediate angle of view on the right side of the entire angle of view, and the third polarized light PL3 is totally reflected by the light guide plate 210 toward the third diffraction unit 230-3. In the image light IL3 incident on the second diffraction unit 230-2, image light IL3-2 including the second polarized light PL2 is diffracted toward the eyeball EB so as to form a central angle of view of the entire angle of view, and the third polarized light PL3 is totally reflected by the light guide plate 210 toward the third diffraction unit 230-3.

In the image light IL1 incident on the third diffraction unit 230-3, image light IL1-3 including the third polarized light PL3 is diffracted toward the eyeball EB so as to form the first intermediate angle of view on the right side of the entire angle of view. In the image light IL2 incident on the third diffraction unit 230-3, image light IL2-3 including the third polarized light PL3 is diffracted toward the eyeball EB so as to form the rightmost angle of view of the entire angle of view. In the image light IL3 incident on the third diffraction unit 230-3, image light IL3-3 including the third polarized light PL3 is diffracted toward the eyeball EB so as to form a second intermediate angle of view between the rightmost angle of view of the entire angle of view and the first intermediate angle of view on the right side.

According to the display device 50 described above, it is possible to display an image at a wider angle of view.

### (Example of Densely Providing Diffraction Units on Both Surfaces of Light Guide Plate)

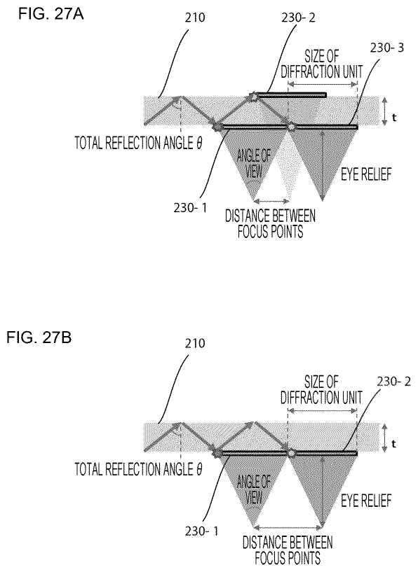

FIG. 27A is a diagram illustrating an example in which diffraction units are densely provided on both surfaces of the light guide plate. FIG. 27B is a diagram illustrating an example in which diffraction units are provided on one surface of the light guide plate. In the example of FIG. 27A, the first and third diffraction units 230-1 and 230-3 are provided adjacent to each other on one surface (for example, the surface on the eyeball side) of the light guide plate 210, and the second diffraction unit 230-2 is provided on the other surface (for example, the surface on the side opposite to the eyeball side) of the light guide plate 210 so as to overlap both the first and third diffraction units 230-1 and 230-3 when viewed from the thickness direction of the light guide plate 210. By densely providing the diffraction units 230 on both surfaces of the light guide plate 210 in this manner, the distance between the adjacent focus points formed by the diffraction units (distance between focus points) can be made, for example, about half the size of the diffraction unit. As a result, the focus points can be formed more densely, deviation of the focus points from the eyeball can be suppressed, and disappearance of an image can be suppressed.

In the example of FIG. 27B, the first and third diffraction units 230-1 and 230-3 are provided adjacent to each other on one surface of the light guide plate 210. In this case, the distance between focus points is about the size of the diffraction unit. In this case, there is a possibility that the focus point deviates from the eyeball and an image disappears.

### 6. Display Device According to Sixth Embodiment of Present Technology

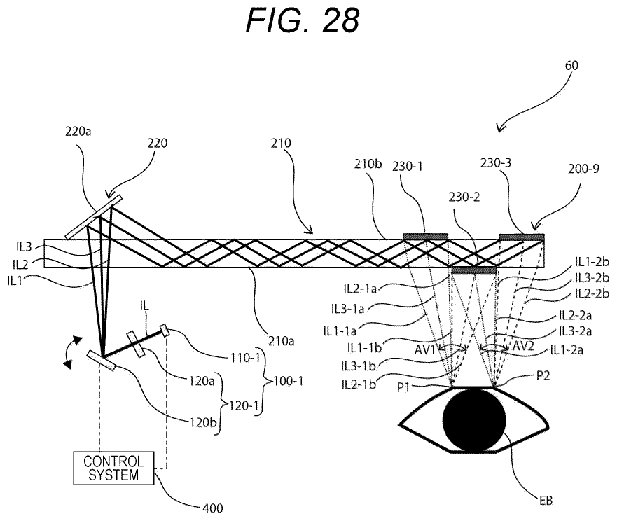

Hereinafter, a display device according to a sixth embodiment of the present technology will be described with reference to the drawings. FIG. 28 is a diagram illustrating a configuration of a display device 60 according to the sixth embodiment of the present technology.

The display device 60 has substantially the same configuration as that of the display device 10 according to the first embodiment except that two focus points P1 and P2 are formed on an eyeball EB by using three diffraction units (for example, first to third diffraction units 230-1 to 230-3).

In a light guide system 200-9 of the display device 60, arrangement of the first to third diffraction units 230-1 to 230-3 is the same as that of the light guide system 200-8 of the display device 50 according to the fifth embodiment.

In the light guide system 200-9, the first diffraction unit 230-1 has polarization selectivity for first polarized light PL1, the second diffraction unit 230-2 has polarization selectivity for the first polarized light PL1 and second polarized light PL2, and the third diffraction unit 230-3 has polarization selectivity for the second polarized light PL2. Here, the diffraction efficiency of each of the first and second diffraction units 230-1 and 230-2 for light in a corresponding polarization state is, for example, about 30% to 70% (preferably 50%).

That is, the first and second diffraction units 230-1 and 230-2 correspond to a same polarization state (first polarized light PL1) and correspond to different polarization states (first and second polarized lights PL1 and PL2). The second and third diffraction units 230-2 and 230-3 correspond to a same polarization state (second polarized light PL2) and correspond to different polarization states (first and second polarized lights PL1 and PL2). The first and third diffraction units 230-1 and 230-3 correspond to different polarization states (first and second polarized lights PL1 and PL2).

As an example, the second diffraction unit 230-2 is a diffraction unit in which a plurality of diffraction patterns corresponding to different polarization states (first and second polarized lights PL1 and PL2) are formed in a multiple manner or a diffraction unit in which a plurality of layers in which diffraction patterns corresponding to different polarization states (first and second polarized lights PL1 and PL2) are formed are stacked.

In the light guide system 200-9, the first and second diffraction units 230-1 and 230-2 form a first angle of view AV1 starting from the focus point P1, and the second and third diffraction units 230-2 and 230-3 form a second angle of view AV2 starting from the focus point P2.

In the display device 60, image light IL (for example, image lights IL1, IL2 and IL3) emitted from an image light generation system 100-1 is incident on a light guide plate 210 via a relay optical system 220, propagated through the light guide plate 210 while being totally reflected repeatedly, and then incident on the first diffraction unit 230-1.

In the image light IL1 incident on the first diffraction unit 230-1, image light IL1-1a including part of the first polarized light PL1 is diffracted toward an eyeball EB so as to form the leftmost angle of view of the first angle of view AV1, and the other part of the first polarized light PL1 and the second polarized light PL2 are totally reflected by the light guide plate 210 toward the second diffraction unit 230-2. In the image light IL2 incident on the first diffraction unit 230-1, image light IL2-1a including part of the first polarized light PL1 is diffracted toward the eyeball EB so as to form a central angle of view of the first angle of view AV1, and the other part of the first polarized light PL1 and the second polarized light PL2 are totally reflected by the light guide plate 210 toward the second diffraction unit 230-2. In the image light IL3 incident on the first diffraction unit 230-1, image light IL3-1a including part of the first polarized light PL1 is diffracted toward the eyeball EB so as to form an intermediate angle of view on the left side of the first angle of view AV1, and the other part of the first polarized light PL and the second polarized light PL2 are totally reflected by the light guide plate 210 toward the second diffraction unit 230-2.

In the image light IL1 incident on the second diffraction unit 230-2, image light IL1-1b including the other part of the first polarized light PL1 is diffracted toward the eyeball EB so as to form the central angle of view of the first angle of view AV1, image light IL1-2a including part of the second polarized light PL2 is diffracted toward the eyeball EB so as to form the leftmost angle of view of the second angle of view AV2, and the other part of the second polarized light PL2 is totally reflected by the light guide plate 210 toward the third diffraction unit 230-3. In the image light IL2 incident on the second diffraction unit 230-2, image light IL2-1b including the other part of the first polarized light PL1 is diffracted toward the eyeball EB so as to form the rightmost angle of view of the first angle of view AV1, image light IL2-2a including part of the second polarized light PL2 is diffracted toward the eyeball EB so as to form a central angle of view of the second angle of view AV2, and the other part of the second polarized light PL2 is totally reflected by the light guide plate 210 toward the third diffraction unit 230-3. In the image light IL3 incident on the second diffraction unit 230-2, image light IL3-1bincluding the other part of the first polarized light PL1 is diffracted toward the eyeball EB so as to form an intermediate angle of view on the right side of the first angle of view AV1, image light IL3-2a including part of the second polarized light PL2 is diffracted toward the eyeball EB so as to form an intermediate angle of view on the left side of the second angle of view AV2, and the other part of the second polarized light PL2 is totally reflected by the light guide plate 210 toward the third diffraction unit 230-3.

In the image light IL1 incident on the third diffraction unit 230-3, image light IL1-2b including the other part of the second polarized light PL2 is diffracted toward the eyeball EB so as to form the central angle of view of the second angle of view AV2. In the image light IL2 incident on the third diffraction unit 230-3, image light IL2-2b including the other part of the second polarized light PL2 is diffracted toward the eyeball EB so as to form the rightmost angle of view of the second angle of view AV2. In the image light IL3 incident on the third diffraction unit 230-3, image light IL3-2b including the other part of the second polarized light PL2 is diffracted toward the eyeball EB so as to form the intermediate angle of view on the right side of the second angle of view AV2.

According to the display device 60 described above, disappearance of an image can be effectively suppressed.

### 7. Display Device According to Seventh Embodiment of Present Technology

Hereinafter, a display device according to a seventh embodiment of the present technology will be described in detail with some examples.

### (Example 1)

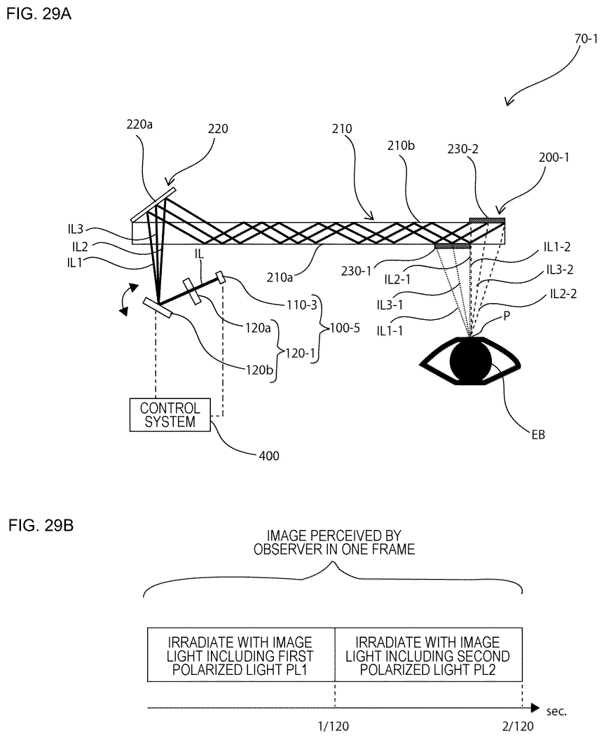

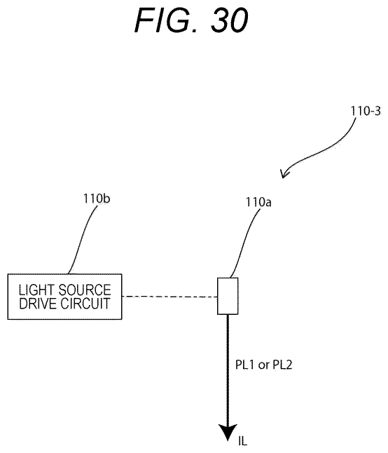

FIG. 29A is a diagram illustrating a configuration of a display device 70-1 according to Example 1 of the seventh embodiment of the present technology. FIG. 29B is a diagram for explaining a display method of the display device 70-1 according to Example 1 of the seventh embodiment of the present technology. FIG. 30 is a diagram illustrating a configuration example of a light source unit 110-3 of the display device 70-1.

The display device 70-1 has a configuration substantially similar to that of the display device 10 according to the first embodiment except that the light source unit 110-3 generates image light IL by using a single light source 110a (see FIG. 30).

In the light source unit 110-3, the light source 110a is a polarized light source capable of selectively emitting first and second polarized lights PL1 and PL2 (see FIG. 30).

In the display device 70-1, a plurality of lights (for example, the first and second polarized lights PL1 and PL2) having different polarization states, the plurality of lights being included in the image light IL, is incident on a plurality of corresponding diffraction units (for example, first and second diffraction units 230-1 and 230-2) in different time zones (see FIG. 29B).

As an example, the display device 70-1 irradiates an eyeball EB with image light (for example, IL1-1, IL2-1, IL3-1) including the first polarized light PL1 in a first time zone (for example, 0 to 1/120 seconds) to form a left-half angle of view region of the entire angle of view starting from a focus point P, and irradiates the eyeball EB with image light (for example, IL1-2, IL2-2, IL3-2) including the second polarized light PL2 in a second time zone (for example, 1/120 to 2/120 seconds) to form a right-half angle of view region of the entire angle of view starting from the focus point P. That is, an image perceived by the user as an observer is formed in one frame including the first and second time zones.

According to the display device 70-1, it is possible to stably display an image with a wide angle of view with high image quality by using a single light source.

### (Example 2)

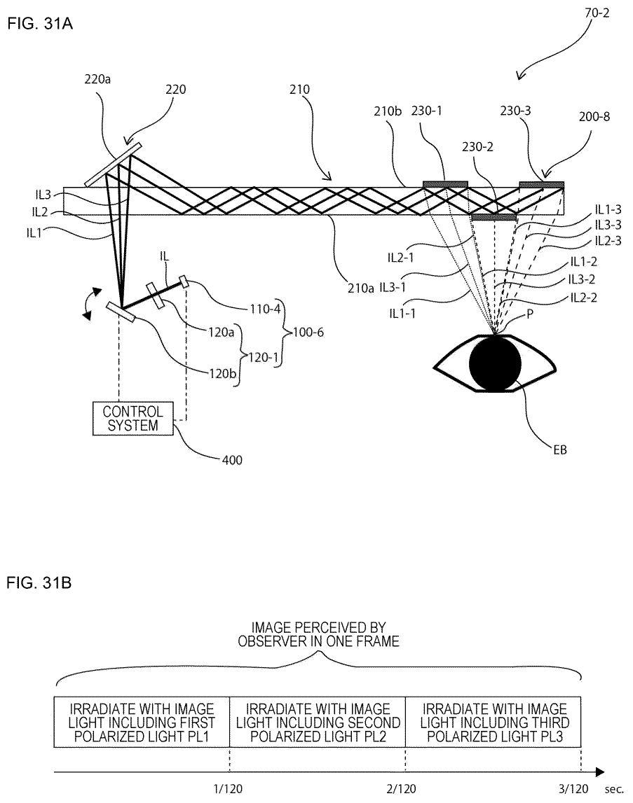

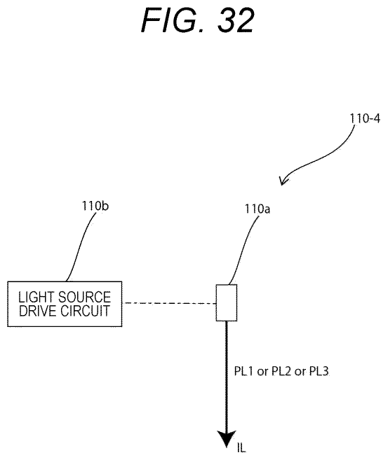

FIG. 31A is a diagram illustrating a configuration of a display device 70-2 according to Example 2 of the seventh embodiment of the present technology. FIG. 31B is a diagram for explaining a display method of the display device 70-2 according to Example 2 of the seventh embodiment of the present technology. FIG. 32 is a diagram illustrating a configuration example of a light source unit 110-4 of the display device 70-2.

The display device 70-2 has a configuration substantially similar to that of the display device 50 according to the fifth embodiment except that the light source unit 110-4 generates image light IL by using the single light source 110a (see FIG. 32).

In the light source unit 110-4, the light source 110a is a polarized light source capable of selectively emitting first to third polarized lights PL1, PL2, and PL3 (see FIG. 32).

In the display device 70-2, a plurality of lights (for example, the first to third polarized lights PL1, PL2, and PL3) having different polarization states, the plurality of lights being included in the image light IL, is incident on a plurality of corresponding diffraction units (for example, the first to third diffraction units 230-1, 230-2, and 230-3) in different time zones (see FIG. 31B).

As an example, the display device 70-2 irradiates the eyeball EB with image light (for example, IL1-1, IL2-1, IL3-1) including the first polarized light PL1 in a first time zone (for example, 0 to 1/120 seconds) to form an angle of view region on the left side of the entire angle of view starting from the focus point P, irradiates the eyeball EB with image light (for example, IL1-2, IL2-2 and IL3-2) including the second polarized light PL2 in a second time zone (for example, 1/120 to 2/120 seconds) to form a central angle of view region of the entire angle of view starting from the focus point P, and irradiates the eyeball EB with image light (for example, IL1-3, IL2-3 and IL3-3) including the third polarized light PL3 in a third time zone ( 2/120 to 3/120 seconds) to form an angle of view on the right side of the entire angle of view starting from the focus point P. That is, an image perceived by the user as an observer is formed in one frame including the first to third time zones.

According to the display device 70-2, it is possible to stably display an image with a wider angle of view with high image quality by using a single light source.

### (Example 3)

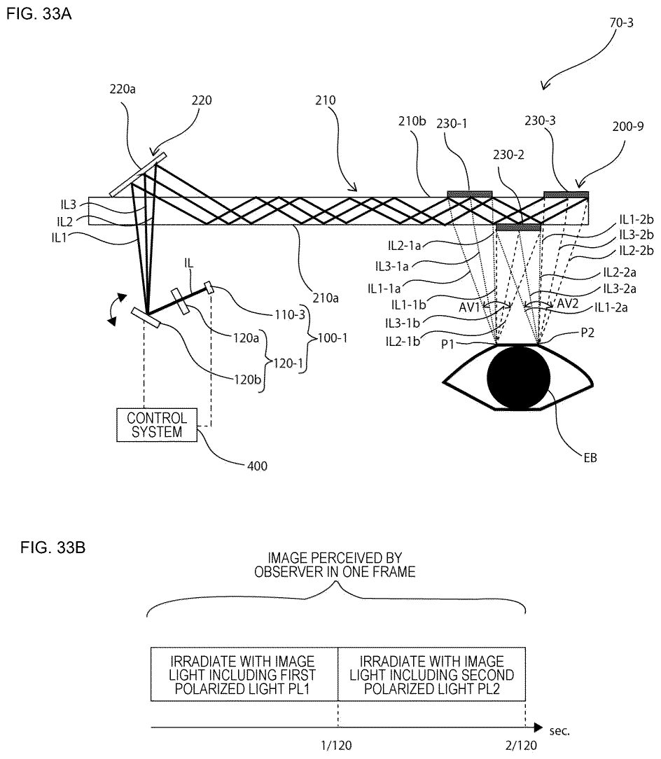

FIG. 33A is a diagram illustrating a configuration of a display device 70-3 according to Example 3 of the seventh embodiment of the present technology. FIG. 33B is a diagram for explaining a display method of the display device 70-3 according to Example 3 of the seventh embodiment of the present technology.

The display device 70-3 has a configuration substantially similar to that of the display device 60 according to the sixth embodiment except that the light source unit 110-3 generates image light IL by using the single light source 110a (see FIG. 30).

In the light source unit 110-3, the light source 110a can selectively emit first and second polarized lights PL1 and PL2 (see FIG. 30).

In the display device 70-3, a plurality of lights (for example, the first and second polarized lights PL1 and PL2) having different polarization states, the plurality of lights being included in the image light IL, is incident on a plurality of corresponding diffraction units (for example, the first and second diffraction units 230-1 and 230-2) in different time zones (see FIG. 33B).

As an example, the display device 70-3 irradiates the eyeball EB with image light (for example, IL1-1a, IL1-1b, IL2-1a, IL2-1b, IL3-1a, and IL3-1b) including the first polarized light PL1 in a first time zone (for example, 0 to 1/120 seconds) to form a first angle of view AV1 starting from a focus point P1, and irradiates the eyeball EB with image light (for example, IL1-2a, IL1-2b, IL2-2a, IL2-2b, IL3-2a, and IL3-2b) including the second polarized light PL2 in a second time zone (for example, 1/120 to 2/120 seconds) to form a second angle of view AV2 starting from a focus point P2. That is, an image perceived by the user as an observer is formed in one frame including the first and second time zones.

According to the display device 70-3, it is possible to stably display an image with a wide angle of view with high image quality while effectively suppressing disappearance of the image by using a single light source.

### 8. Modification of Present Technology

The configuration of the display device of each embodiment of the present technology described above can be appropriately changed.

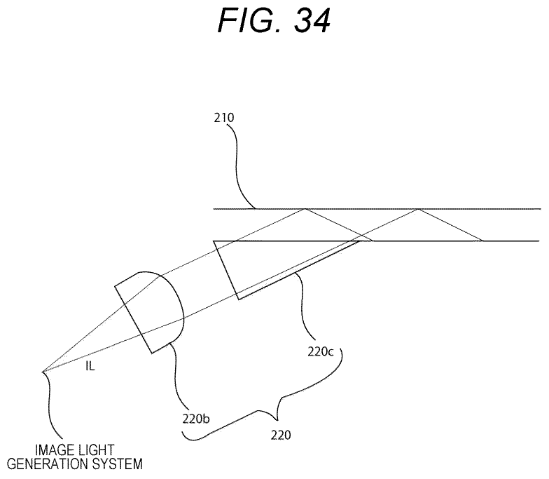

The configuration of the relay optical system 220 can be changed as appropriate. For example, in Modification 1 illustrated in FIG. 34, the relay optical system 220 includes a collimator lens 220b arranged on the optical path of the image light IL from the image light generation system, and a prism 220c arranged on an optical path of the image light IL via the collimator lens 220b. The prism 220c is attached to one surface (for example, a surface on the eyeball side) of the light guide plate 210. The image light IL emitted from the image light generation system is converted into substantially parallel light by the collimator lens 220b, and is incident on the light guide plate 210 via the prism 220c at an incident angle satisfying the total reflection condition in the light guide plate 210.

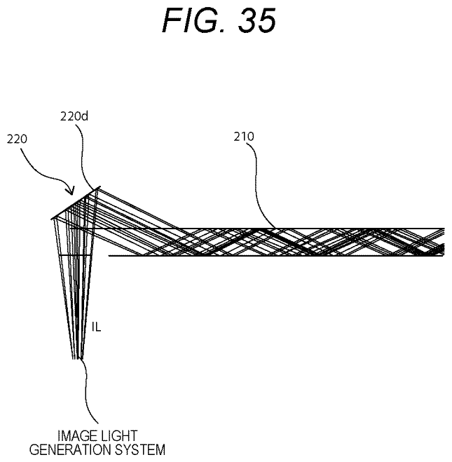

For example, in Modification 2 illustrated in FIG. 35, the relay optical system 220 includes a free-form surface prism 220d arranged on the optical path of the image light IL from the image light generation system. For example, the free-form surface prism 220d is attached to one surface (for example, a surface on a side opposite to the eyeball side) of the light guide plate 210. The image light IL emitted from the image light generation system is totally reflected and converted into substantially parallel light by the free-form surface prism, and is incident on the light guide plate 210 at an incident angle satisfying the total reflection condition in the light guide plate 210.

For example, at least one diffraction unit 230 having polarization selectivity and at least one diffraction unit not having polarization selectivity may be combined to display a wide angle-of-view image. In this case, for example, if the diffraction efficiency of the diffraction unit 230 for the light in the corresponding polarization state is high, it is also possible to stably display a wide angle-of-view image with high image quality while suppressing generation of stray light.

For example, in each of the embodiments and modifications described above, image light including a plurality of polarized lights is emitted from the light source unit, but image light including a plurality of polarized lights and at least one non-polarized light may be emitted from the light source unit, or image light including at least one polarized light and at least one non-polarized light may be emitted from the light source unit. In this case, at least one diffraction unit having polarization selectivity and at least one diffraction unit not having polarization selectivity may be provided. For example, in a case where at least one diffraction unit has a single polarization selectivity, a single polarized light corresponding to the single polarization selectivity may be emitted from the light source unit. In this case, moreover, at least one non-polarized light may be emitted from the light source unit in addition to the single polarized light.

The number and arrangement of the diffraction units 230 are not limited to the embodiments and modifications described above. For example, the number and arrangement can be appropriately changed according to the size of the entire angle of view of the display image, the size of the diffraction unit 230, the number of polarized lights having different polarization states included in the image light, the presence or absence of a diffraction unit having no polarization selectivity, and the like. In this case, at least one diffraction unit 230 may have polarization selectivity for a plurality of polarized lights. Specifically, the at least one diffraction unit 230 may be a diffraction unit in which a plurality of diffraction patterns corresponding to different polarization states is formed in a multiple manner or a diffraction unit in which a plurality of layers in which diffraction patterns corresponding to different polarization states are formed is stacked. In a case where a plurality of diffraction units 230 is provided, at least two diffraction units 230 may correspond to the same polarization state or may correspond to different polarization states. For example, at least two diffraction units 230 corresponding to the same polarization state may be provided at at least two continuous total reflection positions on the light guide plate 210, respectively. In this case, by emitting light in the same polarization state corresponding to each diffraction unit from the light source unit and adjusting the diffraction efficiency of at least one diffraction unit 230, image light of a substantially equal light amount can be incident on each diffraction unit 230.

In each of the embodiments and modifications described above, the diffraction units 230 are provided on both surfaces of the light guide plate 210, but may be provided only on one surface.

In each of the embodiments and modifications described above, the light source unit includes a polarized light source, but in addition to or instead of this, a non-polarized light source and at least one wave plate (for example, a half-wave plate, a quarter-wave plate) may be combined to generate a plurality of polarized lights having different polarization states.

For example, in each of the embodiments and modifications described above, the light guide system may not include the light guide plate. For example, the light guide system may include at least one mirror.

The configurations of the embodiments and modifications described above may be combined with each other within a range not contradictory.

Furthermore, the present technology may also adopt the following configurations.
(1) A display device including:
   an image light generation system that generates image light; and
   a light guide system that guides the image light generated by the image light generation system to an eyeball of a user;
   in which the light guide system includes a diffraction unit having polarization selectivity,
   at least light in a corresponding polarization state, the at least light being included in the image light, is incident on the diffraction unit, and
   the diffraction unit diffracts the light in the corresponding polarization state, the at least light being incident, toward the eyeball.
(2) The display device according to (1), in which the light guide system includes a plurality of the diffraction units.
(3) The display device according to (2), in which at least two diffraction units among the plurality of diffraction units correspond to different polarization states.
(4) The display device according to (2) or (3), in which at least two diffraction units of the plurality of diffraction units correspond to a same polarization state.
(5) The display device according to (2) to (4), in which the plurality of diffraction units includes at least two diffraction units corresponding to different polarization states and at least two diffraction units corresponding to a same polarization state.
(6) The display device according to any one of (2) to (5), in which the plurality of diffraction units each causes light in corresponding polarization state to be incident on the eyeball from directions different from each other.
(7) The display device according to any one of (2) to (6), in which the light guide system includes a light guide plate that faces the eyeball and totally reflects and guides the image light which is generated by the image light generation system and is incident, and the plurality of diffraction units is provided on the light guide plate.
(8) The display device according to (7), in which the plurality of diffraction units includes at least one diffraction unit provided on a surface of the light guide plate on a side of the eyeball and/or at least one diffraction unit provided on a surface of the light guide plate on a side opposite to the side of the eyeball.
(9) The display device according to (7) or (8), in which the light guide system includes a relay optical system that causes the image light generated by the image light generation system to be incident on the light guide plate at an incident angle at which the image light is totally reflected in the light guide plate.
(10) The display device according to any one of (1) to (9), in which the light in the corresponding polarization state includes circularly polarized light, and the diffraction unit has circular polarization selectivity.
(11) The display device according to any one of (2) to (10), in which the light in the corresponding polarization state includes circularly polarized light, the plurality of diffraction units includes a first diffraction unit on which at least first circularly polarized light included in the image light is incident and a second diffraction unit on which at least second circularly polarized light having a polarization direction different from a polarization direction of the first circularly polarized light, the second circularly polarized light being included in the image light, is incident, the first diffraction unit has polarization selectivity for the first circularly polarized light, and the second diffraction unit has polarization selectivity for the second circularly polarized light.
(12) The display device according to (11), in which each of the first diffraction unit and the second diffraction unit includes a cholesteric liquid crystal element.
(13) The display device according to (12), in which a rotation direction of a liquid crystal molecule in the cholesteric liquid crystal element of the first diffraction unit is opposite to a rotation direction of a liquid crystal molecule in the cholesteric liquid crystal element of the second diffraction unit.
(14) The display device according to (12) or (13), in which in the cholesteric liquid crystal element of each of the first diffraction unit and the second diffraction unit, an alignment direction of a liquid crystal molecule is inclined with respect to a thickness direction of the cholesteric liquid crystal element.
(15) The display device according to any one of (1) to (14), in which the light guide system includes at least one retardation film arranged on an optical path of the image light.
(16) The display device according to any one of (1) to (15), in which the diffraction unit includes a diffraction unit in which a plurality of diffraction patterns corresponding to different polarization states is formed in a multiple manner or a diffraction unit in which a plurality of layers in which diffraction patterns corresponding to different polarization states are formed is stacked.
(17) The display device according to any one of (1) to (16), in which the image light generation system includes a light source unit including a light source, and an optical deflector that deflects light from the light source unit.
(18) The display device according to (17), in which the image light generation system includes another diffraction unit that is arranged on an optical path of the image light between the light source unit and the optical deflector and corrects chromatic aberration of the diffraction unit.
(19) The display device according to (17) or (18), in which the image light generation system includes an optical element that is arranged on an optical path of the image light between the light source unit and the optical deflector and an optical element control unit that controls the optical element.
(20) The display device according to any one of (2) to (19), in which a plurality of lights having different polarization states, the plurality of lights being included in the image light, is incident on the plurality of corresponding diffraction units in different time zones.

### REFERENCE SIGNS LIST

10, 20-1 to 20-6, 30, 40, 50, 60, 70-1 to 70-3 Display device
100-1 to 100-6 Image light generation system
110a, 110a1, 110a2, 110a3 Light source
110-1 to 110-4 Light source unit
120a Optical element
120b Optical deflector
120c Another diffraction unit
120d Drive unit
200-1 to 200-9 Light guide system
210 Light guide plate
220 Relay optical system
230, 230-1, 230-2, 230-3 Diffraction unit
240, 240-1, 240-2, 240-3 Retardation film
IL, IL1, IL2, IL3 Image light
EB Eyeball

1. A display device comprising:
an image light generation system that generates image light; and
a light guide system that guides the image light generated by the image light generation system to an eyeball of a user;
wherein the light guide system includes a diffraction unit having polarization selectivity,
at least light in a corresponding polarization state, the at least light being included in the image light, is incident on the diffraction unit, and
the diffraction unit diffracts the light in the corresponding polarization state, the at least light being incident, toward the eyeball.

2. The display device according to claim 1, wherein the light guide system includes a plurality of the diffraction units.

3. The display device according to claim 2, wherein at least two diffraction units of the plurality of diffraction units correspond to different polarization states.

4. The display device according to claim 2, wherein at least two diffraction units of the plurality of diffraction units correspond to a same polarization state.

5. The display device according to claim 2, wherein the plurality of diffraction units includes at least two diffraction units corresponding to different polarization states and at least two diffraction units corresponding to a same polarization state.

6. The display device according to claim 2, wherein the plurality of diffraction units each causes light in corresponding polarization state to be incident on the eyeball from directions different from each other.

7. The display device according to claim 2,
wherein the light guide system includes a light guide plate that faces the eyeball and totally reflects and guides the image light which is generated by the image light generation system and is incident, and
the plurality of diffraction units is provided on the light guide plate.

8. The display device according to claim 7, wherein the plurality of diffraction units includes at least one diffraction unit provided on a surface of the light guide plate on a side of the eyeball and/or at least one diffraction unit provided on a surface of the light guide plate on a side opposite to the side of the eyeball.

9. The display device according to claim 7, wherein the light guide system includes a relay optical system that causes the image light generated by the image light generation system to be incident on the light guide plate at an incident angle at which the image light is totally reflected in the light guide plate.

10. The display device according to claim 1,
wherein the light in the corresponding polarization state includes circularly polarized light, and
the diffraction unit has circular polarization selectivity.

11. The display device according to claim 2,
wherein the light in the corresponding polarization state includes circularly polarized light,
the plurality of diffraction units includes a first diffraction unit on which at least first circularly polarized light included in the image light is incident and a second diffraction unit on which at least second circularly polarized light having a polarization direction different from a polarization direction of the first circularly polarized light, the second circularly polarized light being included in the image light, is incident,
the first diffraction unit has polarization selectivity for the first circularly polarized light, and
the second diffraction unit has polarization selectivity for the second circularly polarized light.

12. The display device according to claim 11, wherein each of the first diffraction unit and the second diffraction unit includes a cholesteric liquid crystal element.

13. The display device according to claim 12, wherein a rotation direction of a liquid crystal molecule in the cholesteric liquid crystal element of the first diffraction unit is opposite to a rotation direction of a liquid crystal molecule in the cholesteric liquid crystal element of the second diffraction unit.

14. The display device according to claim 12, wherein in the cholesteric liquid crystal element of each of the first diffraction unit and the second diffraction unit, an alignment direction of a liquid crystal molecule is inclined with respect to a thickness direction of the cholesteric liquid crystal element.

15. The display device according to claim 1, wherein the light guide system includes at least one retardation film arranged on an optical path of the image light.

16. The display device according to claim 1, wherein the diffraction unit includes a diffraction unit in which a plurality of diffraction patterns corresponding to different polarization states is formed in a multiple manner or a diffraction unit in which a plurality of layers in which diffraction patterns corresponding to different polarization states are formed is stacked.

17. The display device according to claim 1,
wherein the image light generation system includes
a light source unit including a light source, and
an optical deflector that deflects light from the light source unit.

18. The display device according to claim 17, wherein the image light generation system includes another diffraction unit that is arranged on an optical path of the image light between the light source unit and the optical deflector and corrects chromatic aberration of the diffraction unit.

19. The display device according to claim 17,
wherein the image light generation system includes
an optical element that is arranged on an optical path of the image light between the light source unit and the optical deflector, and
an optical element control unit that controls the optical element.

20. The display device according to claim 2, wherein a plurality of lights having different polarization states, the plurality of lights being included in the image light, is incident on the plurality of corresponding diffraction units in different time zones.
